(19) United States
(12) Patent Application Publication
(10) Pub. No.: US 2025/0374099 A1
(43) Pub. Date: Dec. 4, 2025

(54) TECHNIQUES FOR CHANNEL MEASUREMENT WITH PREDICTIVE BEAM MANAGEMENT

(71) Applicant: QUALCOMM INCORPORATED, San Diego, CA (US)

(72) Inventors: Qiaoyu Li, Beijing (CN); Tao Luo, San Diego, CA (US); Mahmoud Taherzadeh Boroujeni, San Diego, CA (US); Hamed Pezeshki, San Diego, CA (US)

(21) Appl. No.: 18/875,085

(22) PCT Filed: Jul. 28, 2022
(86) PCT No.: PCT/CN2022/108450

§ 371 Date: Dec. 13, 2024

(51) Int. Cl. H04W 24/10; H04B 7/06; H04L 5/00; H04W 72/044

(52) U.S. Cl. CPC H04W 24/10; H04B 7/0695; H04L 5/0048; H04W 72/046

(57) ABSTRACT

Methods, systems, and devices for wireless communications are described. For example, a UE may receive, and a network entity may transmit, a channel state information (CSI) resource setting indicating a set of channel measurement resources (CMR) to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The UE may perform the channel state measurement procedure based on the set of CMRs and the set of nominal resources. The UE may transmit, and the network entity may receive, a measurement report associated with the set of CMRs, or the set of nominal resources, or any combination thereof.

### CROSS REFERENCE

The present Application is a 371 national stage filing of International PCT Application No. PCT/CN2022/108450 by Li et al. entitled “TECHNIQUES FOR CHANNEL MEASUREMENT WITH PREDICTIVE BEAM MANAGEMENT,” filed Jul. 28, 2022, which is assigned to the assignee hereof, and which is expressly incorporated by reference in its entirety herein.

### FIELD OF TECHNOLOGY

The following relates to wireless communications, including techniques for channel measurement with predictive beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for channel measurement with predictive beam management. For example, the described techniques provide for reporting beam parameters for multiple sets of resources. In some examples, a network entity may indicate a first set of resources and a second set of resources to a UE via a channel state information (CSI) resource setting. In some cases, the first set may be a set of channel measurement resource (CMR) and the second set may be a set of nominal resources, or channel prediction resources (CPR). In some examples, the UE may perform one or more measurements or predictions using the indicated first and second sets of resources. For example, the network entity may transmit one or more reference signals for the first set of resources (e.g., using a first set of beams) and one or more reference signals for the second set of resources (e.g., using a second set of beams). In some examples, the network entity may refrain from transmitting reference signals for the second set of resources. In response, the UE may perform one or more measurements using the first set of resources and corresponding reference signals/beams, and may perform one or more predictions using the second set of resources and corresponding reference signals/beams based on the measurements. The UE may then transmit a measurement report indicating one or more measured or predicted parameters. In some examples, the UE may transmit the predicted parameters in the report, and may refrain from transmitting the measured parameters.

A method for wireless communication at a user equipment (UE) is described. The method may include receiving, from a network entity, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted, performing the channel state measurement procedure based on the set of channel measurement resources and the set of nominal resources, and transmitting a measurement report associated with the set of channel measurement resources, or the set of nominal resources, or any combination thereof.

An apparatus for wireless communication at a UE is described. The apparatus may include a processor and a memory coupled with the processor, with instructions stored in the memory. The instructions may be executable by the processor to cause the apparatus to receive, from a network entity, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted, perform the channel state measurement procedure based on the set of channel measurement resources and the set of nominal resources, and transmit a measurement report associated with the set of channel measurement resources, or the set of nominal resources, or any combination thereof.

Another apparatus for wireless communication at a UE is described. The apparatus may include means for receiving, from a network entity, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted, means for performing the channel state measurement procedure based on the set of channel measurement resources and the set of nominal resources, and means for transmitting a measurement report associated with the set of channel measurement resources, or the set of nominal resources, or any combination thereof.

A non-transitory computer-readable medium storing code for wireless communication at a UE is described. The code may include instructions executable by a processor to receive, from a network entity, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted, perform the channel state measurement procedure based on the set of channel measurement resources and the set of nominal resources, and transmit a measurement report associated with the set of channel measurement resources, or the set of nominal resources, or any combination thereof.

In some examples of the method, apparatuses, and non-transitory computer-readable medium described herein, receiving the channel state information resource setting may include operations, features, means, or instructions for receiving the channel state information resource setting indicating that the set of nominal resources includes a set of channel prediction resources.

Some examples of the method, apparatuses, and non-transitory computer-readable medium described herein may further include operations, features, means, or instructions for transmitting a channel measurement parameter associated with the set of channel measurement resources and a channel prediction parameter associated with the set of channel prediction resources.

Some examples of the method, apparatuses, and non-transitory computer-readable medium described herein may further include operations, features, means, or instructions for determining a quantity of channel parameters to be measured for the set of channel measurement resources and the set of channel prediction resources and transmitting a set of channel parameters associated with the set of channel measurement resources and the set of channel prediction resources based on the quantity of channel parameters.

Some examples of the method, apparatuses, and non-transitory computer-readable medium described herein may further include operations, features, means, or instructions for transmitting a bitmap indicating a set of channel measurement parameters associated with the set of channel measurement resources and a set of channel prediction parameters associated with the set of channel prediction resources.

Some examples of the method, apparatuses, and non-transitory computer-readable medium described herein may further include operations, features, means, or instructions for transmitting a set of bits including an indication of a set of channel measurement parameters associated with the set of channel measurement resources and a set of channel prediction parameters associated with the set of channel prediction resources, where a quantity of the set of channel measurement parameters may be equal to a quantity of the set of channel prediction parameters and transmitting the set of channel measurement parameters and the set of channel prediction parameters, where the measurement report includes a single-part channel state information report.

Some examples of the method, apparatuses, and non-transitory computer-readable medium described herein may further include operations, features, means, or instructions for transmitting a first set of bits including an indication of a set of channel measurement parameters associated with the set of channel measurement resources and a second set of bits including an indication of a set of channel prediction parameters associated with the set of channel prediction resources, where a quantity of the set of channel measurement parameters may be different from a quantity of the set of channel prediction parameters and transmitting the set of channel measurement parameters and the set of channel prediction parameters, where the measurement report includes a two-part channel state information report.

In some examples of the method, apparatuses, and non-transitory computer-readable medium described herein, performing the channel state measurement procedure may include operations, features, means, or instructions for performing the channel state measurement procedure using a subset of the set of channel measurement resources and a subset of the set of nominal resources based on receiving the channel state information resource setting.

Some examples of the method, apparatuses, and non-transitory computer-readable medium described herein may further include operations, features, means, or instructions for transmitting, to the network entity, a request to use a subset of the set of channel measurement resources and a subset of the set of nominal resources in performing the channel state measurement procedure.

In some examples of the method, apparatuses, and non-transitory computer-readable medium described herein, receiving the channel state information resource setting may include operations, features, means, or instructions for receiving the channel state information resource setting associated with the measurement report indicating that the set of channel measurement resources includes a first subset of channel resources and the set of nominal resources includes a second subset of the channel resources.

In some examples of the method, apparatuses, and non-transitory computer-readable medium described herein, receiving the channel state information resource setting may include operations, features, means, or instructions for receiving a control signal indicating a partitioning between channel resources, where the set of channel measurement resources includes a first subset of channel resources and the set of nominal resources includes a second subset of the channel resources in accordance with the partitioning.

In some examples of the method, apparatuses, and non-transitory computer-readable medium described herein, the control signal includes at least one of a medium access control (MAC) control element activating a semi-persistent channel state information report, a media access control (MAC) control element activating a semi-persistent channel state information resource set, an aperiodic channel state information triggering state configuration, a downlink control information, or any combination thereof.

In some examples of the method, apparatuses, and non-transitory computer-readable medium described herein, the set of channel measurement resources may be associated with a first set of beams and the set of nominal resources may be associated with a second set of beams.

In some examples of the method, apparatuses, and non-transitory computer-readable medium described herein, the set of nominal resources may be based on an enhanced channel state information reference signal resource set configuration or a synchronization signal block resource set configuration.

In some examples of the method, apparatuses, and non-transitory computer-readable medium described herein, receiving the channel state information resource setting may include operations, features, means, or instructions for receiving the channel state information resource setting indicating that the set of channel measurement resources includes a first subset of channel resources and the set of nominal resources includes a second subset of the channel resources, where the second subset of the channel resources may be not indicated by the network entity.

Some examples of the method, apparatuses, and non-transitory computer-readable medium described herein may further include operations, features, means, or instructions for receiving a request to perform the channel state measurement procedure based on the set of channel measurement resources in accordance with a first frequency and based on the set of nominal resources in accordance with a second frequency different from the first frequency.

In some examples of the method, apparatuses, and non-transitory computer-readable medium described herein, a periodicity for the set of channel measurement resources may be longer than a periodicity for the set of nominal resources.

Some examples of the method, apparatuses, and non-transitory computer-readable medium described herein may further include operations, features, means, or instructions for receiving a selection of one of the set of channel measurement resources or the set of nominal resources for the measurement report, where transmitting the measurement report may be based on the received selection.

In some examples of the method, apparatuses, and non-transitory computer-readable medium described herein, the measurement report includes at least one of a periodic channel state information report, a semi-persistent channel state information report, an aperiodic channel state information report, or any combination thereof.

A method for wireless communication at a network entity is described. The method may include transmitting, to a UE, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted and receiving a measurement report associated with the set of channel measurement resources, or the set of nominal resources, or any combination thereof, where the measurement report is based on performing the channel state measurement procedure using the set of channel measurement resources and the set of nominal resources.

An apparatus for wireless communication at a network entity is described. The apparatus may include a processor and a memory coupled with the processor, with instructions stored in the memory. The instructions may be executable by the processor to cause the apparatus to transmit, to a UE, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted and receive a measurement report associated with the set of channel measurement resources, or the set of nominal resources, or any combination thereof, where the measurement report is based on performing the channel state measurement procedure using the set of channel measurement resources and the set of nominal resources.

Another apparatus for wireless communication at a network entity is described. The apparatus may include means for transmitting, to a UE, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted and means for receiving a measurement report associated with the set of channel measurement resources, or the set of nominal resources, or any combination thereof, where the measurement report is based on performing the channel state measurement procedure using the set of channel measurement resources and the set of nominal resources.

A non-transitory computer-readable medium storing code for wireless communication at a network entity is described. The code may include instructions executable by a processor to transmit, to a UE, a channel state information resource setting indicating a set of channel measurement resources to be used in performing a channel state measurement procedure and a set of nominal resources to be used in predicting a channel state in the channel state measurement procedure, where the set of channel measurement resources is transmitted with a first periodicity and the set of nominal resources is either transmitted with a second periodicity different from the first periodicity or not transmitted and receive a measurement report associated with the set of channel measurement resources, or the set of nominal resources, or any combination thereof, where the measurement report is based on performing the channel state measurement procedure using the set of channel measurement resources and the set of nominal resources.

In some examples of the method, apparatuses, and non-transitory computer-readable medium described herein, transmitting the channel state information resource setting may include operations, features, means, or instructions for transmitting the channel state information resource setting indicating that the set of nominal resources includes a set of channel prediction resources.

Some examples of the method, apparatuses, and non-transitory computer-readable medium described herein may further include operations, features, means, or instructions for receiving a channel measurement parameter associated with the set of channel measurement resources and a channel prediction parameter associated with the set of channel prediction resources.

Some examples of the method, apparatuses, and non-transitory computer-readable medium described herein may further include operations, features, means, or instructions for determining a quantity of channel parameters to be measured for the set of channel measurement resources and the set of channel prediction resources and receiving a set of channel parameters associated with the set of channel measurement resources and the set of channel prediction resources based on the quantity of channel parameters.

Some examples of the method, apparatuses, and non-transitory computer-readable medium described herein may further include operations, features, means, or instructions for receiving a bitmap indicating a set of channel measurement parameters associated with the set of channel measurement resources and a set of channel prediction parameters associated with the set of channel prediction resources.

Some examples of the method, apparatuses, and non-transitory computer-readable medium described herein may further include operations, features, means, or instructions for receiving a set of bits including an indication of a set of channel measurement parameters associated with the set of channel measurement resources and a set of channel prediction parameters associated with the set of channel prediction resources, where a quantity of the set of channel measurement parameters may be equal to a quantity of the set of channel prediction parameters and receiving the set of channel measurement parameters and the set of channel prediction parameters, where the measurement report includes a single-part channel state information report.

Some examples of the method, apparatuses, and non-transitory computer-readable medium described herein may further include operations, features, means, or instructions for receiving a first set of bits including an indication of a set of channel measurement parameters associated with the set of channel measurement resources and a second set of bits including an indication a set of channel prediction parameters associated with the set of channel prediction resources, where a quantity of the set of channel measurement parameters may be different from a quantity of the set of channel prediction parameters and receiving the set of channel measurement parameters and the set of channel prediction parameters, where the measurement report includes a two-part channel state information report.

Some examples of the method, apparatuses, and non-transitory computer-readable medium described herein may further include operations, features, means, or instructions for receiving, from the UE, a request to use a subset of the set of channel measurement resources and a subset of the set of nominal resources in performing the channel state measurement procedure.

In some examples of the method, apparatuses, and non-transitory computer-readable medium described herein, transmitting the channel state information resource setting may include operations, features, means, or instructions for transmitting the channel state information resource setting associated with the measurement report indicating that the set of channel measurement resources includes a first subset of channel resources and the set of nominal resources includes a second subset of the channel resources.

In some examples of the method, apparatuses, and non-transitory computer-readable medium described herein, transmitting the channel state information resource setting may include operations, features, means, or instructions for transmitting a control signal indicating a partitioning between channel resources, where the set of channel measurement resources includes a first subset of channel resources and the set of nominal resources includes a second subset of the channel resources in accordance with the partitioning.

In some examples of the method, apparatuses, and non-transitory computer-readable medium described herein, the control signal includes at least one of a medium access control (MAC) control element activating a semi-persistent channel state information report, a MAC control element activating a semi-persistent channel state information resource set, an aperiodic channel state information triggering state configuration, a downlink control information, or any combination thereof.

In some examples of the method, apparatuses, and non-transitory computer-readable medium described herein, the set of channel measurement resources may be associated with a first set of beams and the set of nominal resources may be associated with a second set of beams.

Some examples of the method, apparatuses, and non-transitory computer-readable medium described herein may further include operations, features, means, or instructions for refraining from transmitting the second set of beams to the UE.

In some examples of the method, apparatuses, and non-transitory computer-readable medium described herein, the set of nominal resources may be based on an enhanced channel state information reference signal resource set configuration or a synchronization signal block resource set configuration.

In some examples of the method, apparatuses, and non-transitory computer-readable medium described herein, transmitting the channel state information resource setting may include operations, features, means, or instructions for transmitting the channel state information resource setting indicating that the set of channel measurement resources includes a first subset of channel resources and the set of nominal resources includes a second subset of the channel resources, where the second subset of the channel resources may be not indicated by the network entity.

Some examples of the method, apparatuses, and non-transitory computer-readable medium described herein may further include operations, features, means, or instructions for transmitting a request to perform the channel state measurement procedure based on the set of channel measurement resources in accordance with a first frequency and based on the set of nominal resources in accordance with a second frequency different from the first frequency.

In some examples of the method, apparatuses, and non-transitory computer-readable medium described herein, a periodicity for the set of channel measurement resources may be longer than a periodicity for the set of nominal resources.

Some examples of the method, apparatuses, and non-transitory computer-readable medium described herein may further include operations, features, means, or instructions for transmitting a selection of one of the set of channel measurement resources or the set of nominal resources for the measurement report, where transmitting the measurement report may be based on the transmitted selection.

In some examples of the method, apparatuses, and non-transitory computer-readable medium described herein, the measurement report includes at least one of a periodic channel state information report, a semi-persistent channel state information report, an aperiodic channel state information report, or any combination thereof.

### BRIEF DESCRIPTION OF THE DRAWINGS

FIG. 1 illustrates an example of a wireless communications system that supports techniques for channel measurement with predictive beam management in accordance with one or more aspects of the present disclosure.

FIG. 2 illustrates an example of a wireless communications system that supports techniques for channel measurement with predictive beam management in accordance with one or more aspects of the present disclosure.

FIG. 3 illustrates an example of a report diagram that supports techniques for channel measurement with predictive beam management in accordance with one or more aspects of the present disclosure.

FIG. 4 illustrates an example of a report diagram that supports techniques for channel measurement with predictive beam management in accordance with one or more aspects of the present disclosure.

FIG. 5 illustrates an example of an aperiodic report triggering process that supports techniques for channel measurement with predictive beam management in accordance with one or more aspects of the present disclosure.

FIG. 6 illustrates an example of a process flow that supports techniques for channel measurement with predictive beam management in accordance with one or more aspects of the present disclosure.

FIGS. 7 and 8 show block diagrams of devices that support techniques for channel measurement with predictive beam management in accordance with one or more aspects of the present disclosure.

FIG. 9 shows a block diagram of a communications manager that supports techniques for channel measurement with predictive beam management in accordance with one or more aspects of the present disclosure.

FIG. 10 shows a diagram of a system including a device that supports techniques for channel measurement with predictive beam management in accordance with one or more aspects of the present disclosure.

FIGS. 11 and 12 show block diagrams of devices that support techniques for channel measurement with predictive beam management in accordance with one or more aspects of the present disclosure.

FIG. 13 shows a block diagram of a communications manager that supports techniques for channel measurement with predictive beam management in accordance with one or more aspects of the present disclosure.

FIG. 14 shows a diagram of a system including a device that supports techniques for channel measurement with predictive beam management in accordance with one or more aspects of the present disclosure.

FIGS. 15 through 19 show flowcharts illustrating methods that support techniques for channel measurement with predictive beam management in accordance with one or more aspects of the present disclosure.

### DETAILED DESCRIPTION

Wireless communications systems may support predictive beam management using artificial intelligence (AI) or machine learning (ML). Predictive beam management may include two sets of resources, where beam prediction for a second set of resources may be based on measurement results from a first set of resources. Resources for beam reporting may be periodic, semi-persistent, or aperiodic. In some cases, when using periodic and semi-persistent resources, a user equipment (UE) may be configured with a single set of resources for reporting beam measurements. When using aperiodic resources, the UE may be configured with multiple sets of resources, but may only select one set of resources for using in reporting. However, techniques may be lacking for defining reporting measurements of two or more sets of resources.

Techniques are described herein for reporting beam parameters for multiple sets of resources. For example, a network entity may indicate a first resource set and a second resource set to a UE. In some examples, the network entity may transmit reference signals for measuring both resource sets using different periodicities and the UE may report parameters associated with measuring both resource sets. For example, the network entity may transmit reference signals of the second set of resources at a periodicity lower than a periodicity used for transmitting reference signals of the first set of resources. In some examples, the first and second set of resources may include a first set and second set of channel measurement resources (CMR), where the UE or network entity may select a number of top parameters to report for the two sets of CMRs. In some cases, the two resource sets may be subsets of a single set of CMRs. In another example, the first resource set may include a set of CMRs, whereas the second resource set may include a set of channel prediction resources (CPR).

In some examples, the UE may report parameters associated with both sets of resources where reference signals for both sets of resources may be transmitted. Additionally, or alternatively, reference signals for the second set of resources may not be transmitted by the network entity. In some examples, the UE may report quantities associated with the second set of resources and may refrain from reporting quantities associated with the first set of resources, where reference signals for both sets of resources may be transmitted, or where reference signals for the second set of resources may not be transmitted by the network entity. In some cases, the two sets of resources may include periodic or semi-persistent resources. In some examples, the two resource sets may include aperiodic resources, where the UE may include a resource setting indicating multiple CMR sets, multiple CPR sets, or both for selecting two sets of resources. In some examples, for periodic reporting, the UE may be preconfigured using radio resource control (RRC) signaling. In some cases, for semi-persistent reporting, the UE may be configured via MAC-CE. Additionally, or alternatively, for aperiodic reporting, the UE may be preconfigured with aperiodic reporting settings that may be indicated via downlink control information (DCI) for triggering aperiodic reports.

Aspects of the disclosure are initially described in the context of wireless communications systems. Aspects of the disclosure are additionally described in the context of report diagrams, an aperiodic report triggering process, and a process flow. Aspects of the disclosure are further illustrated by and described with reference to apparatus diagrams, system diagrams, and flowcharts that relate to techniques for channel measurement with predictive beam management.

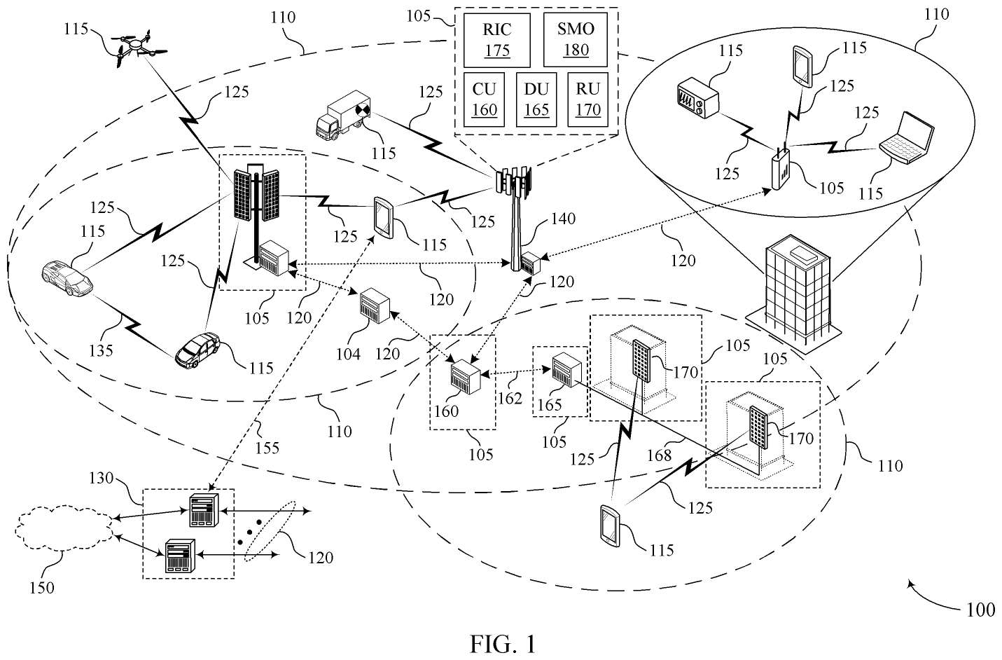

FIG. 1 illustrates an example of a wireless communications system 100 that supports techniques for channel measurement with predictive beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for channel measurement with predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal, such as a cell-specific reference signal (CRS) or a channel state information (CSI) reference signal (CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, to establish communications between the network entity 105 and the UE 115, a network entity 105 and a UE 115 may perform one or more beam management procedures. For example, the network entity 105 and the UE 115 may perform beam sweeping procedures as described herein during an initial access, beam measurement and determination procedures during a connected mode, beam reporting procedures during the connected mode (e.g., L1 report for beam refinement), and beam recovery procedures for a beam failure recovery (BFR) or a radio link failure (RLF). In an initial access procedure, a network entity 105 may transmit in multiple directions (e.g., beams) to synchronize for communications with a UE 115. For example, the network entity 105 may transmit a reference signal, such as a synchronization signal block (SSB), a CSI-RS, or both in a set of directions using supported beams (e.g., may sweep through multiple SSB resources). In some examples, the network entity 105 and UE 115 may use wider beams for the initial access procedure, such as L1 beams. The UE 115 may receive one or more reference signals on the respective beams, and may select or report one or more preferred beams based on a signal metric. The described procedure may also be performed by the network entity 105 for selection of a transmission beam of the UE 115 and for fine tuning of a receive beam at the network entity 105.

In some examples, the UE 115 and a network entity 105 may communicate using one or more different types of beam management procedures, such as a first procedure type for downlink beams (P1), a second procedure type for downlink beams (P2), and a third procedure type for downlink beams (P3), a first procedure type for uplink beams (U1), a second procedure type for uplink beams (U2), and a third procedure type for uplink beams (U3).

In some examples, the network entity 105 and the UE 115 may use hierarchical beam refinement to select narrower beam pairs for communications (e.g., using P1, P2, P3, or any combination thereof). For example, for P1, the network entity 105-a may sweep through multiple wider beams, and the UE 115-a may select a beam and report it to the network entity 105-a. For P2, the network entity 105-a may transmit in multiple relatively narrow directions (e.g., may sweep through multiple narrower beams in a narrower range), where the narrow directions may be based on the direction of the selected wide beam pair. The UE 115 may receive a reference signal on the wide beams, and may report one of the narrow beams to use for transmissions, thus refining the transmission beam. For P3, the network entity 105 may transmit the selected beam repeatedly (e.g., may fix the beam), and the UE 115 may refine a receive beam (e.g., select a narrower receive beam) based on the transmitted beam. In some examples, P1, P2, and P3 processes may be used for downlink beam management.

In some examples, the network entity 105 and the UE 115 may employ uplink beam management procedures for selecting a wide uplink beam pair, refining an uplink receive beam at the network entity 105-a, and refining an uplink transmit beam at the UE 115-a, which may be examples of U1, U2, and U3 processes, respectively. In some cases, the UE 115-a may report beams using a physical layer (e.g., using L1 reporting). In some examples, the UE 115-a and the network entity 105-a may be in a connected mode with successful connection through selected beam pairs.

In some examples, the network entity 105 and the UE 115 may experience a beam failure. For example, the UE 115 may lose a connection with the network entity 105 through the selected beam pairs. In some examples, the UE 115- may perform BFR to select new suitable beam pairs through additional beam sweeping procedures for fast recovery. In some examples, the UE 115 may be unable to find another suitable beam, and may experience RLF, resulting in a loss of connection with the network entity 105. However, such procedures for beam management may present some inefficiencies. For example, due to measurement based identification of beam quality and beam failure, excessive power and overhead may be used to achieve good performance, beam accuracy may be limited due to restrictions on power and overhead, and latency and throughput may be impacted by beam resuming efforts. Thus, a UE 115 and a network entity 105 may use predictive beam management (e.g., in spatial domain, time domain, or frequency domain) to reduce overhead and latency, as well as improve beam selection accuracy.

In some examples, predictive beam management may be improved though the use of AI/ML procedures, where a network entity 105 and a UE 115 may use one or more AI/ML designs for beam change prediction in time or spatial domain to mitigate drawbacks and improve beam sweeping procedures. For example, predicting non-measured beam qualities may reduce power and overhead as well as improve accuracy, and predicting future beam blockage and failure may result in reduced latency and higher throughput. In some cases, beam prediction may be a non-linear problem. For example, predicting future transmission beam qualities may depend on a UE's movement speed and trajectory. Other factors such as reception beam decisions and interference may also contribute to an overall non-linear characteristic of beam prediction problems. Thus, AI/ML-based beam prediction may present advantages over other forms of prediction due to the ability of AI/ML to solve non-linear problems.

In some examples, AI/ML-based beam prediction may involve training at a network entity 105 or network level (e.g., centralized) or at a UE 115 (e.g., distributed). For example, at a network entity 105, data may be collected via enhanced air interfaces or via app-layer approaches, or a UE 115 may include additional computation and buffering for model training and necessary data storage. The UE 115 or the network entity 105 may then perform prediction based on the training at either the UE 115 or the network entity 105. In some examples, a UE 115 may include a greater quantity of observations of different beams (e.g., via measurements) than a network entity 105, where the network entity 105 may receive observations from feedback from the UE 115. Thus, predictions of different beams (e.g., future downlink transmission beam qualities) at the UE 115 may exhibit better performance than at the network entity 105. However, a power tradeoff may exist, where performing predictions at the UE 115 may consume a greater amount of power for interference efforts. Thus, performing predictions at the network entity 105 may save power at the UE 115 at the cost of lower performance.

In some examples, AI/ML-based beam prediction may be used for predicting a second set of beams using a first set of beams as input into an ML-model or other algorithm, resulting in less beam measurements and UE power reduction. In some cases, measurements of the first set of beams may include spatial and time domain compressive beam measurements based on different measurements made at a UE 115 while incorporating interference at the UE 115 and a network entity 105. For example, the UE 115 may measure and report one or more L1 reference signal received powers (L1-RSRP) or other metrics. In some cases, such predictions in the wireless communications system 100 may include codebook based spatial domain selection, including initial access, secondary cell group setup, serving beam refinement, and link quality (e.g., channel quality indicator (CQI)/PMI) and interference adaptation.

Additionally, or alternatively, AI/ML-based beam prediction may be used for predicting different characteristics of beams (e.g., point-direction, angle of departure (AoD), angle of arrival (AoA), etc.), resulting in better beam management accuracy without excessive beam sweeping. For example, based on inputting channels and beams, different non-measured directions may be predicted. In some cases, such predictions may be facilitated via raw channel extraction based on channels or measurements (e.g., L1-RSRPs) reported by a UE 115, incorporating interference at a network entity 105 or a UE 115. In some examples, such predictions may include non-codebook based spatial domain prediction, including serving beam refinement, and link quality (e.g., CQI/PMI) and interference adaptation.

In some cases, such predictions may be made for spatial domain characteristics, time domain characteristics, or both. For example, a time series of reports or measurements made by a UE 115 may be input into one or more MLs or other algorithms to produce a chronological backtracking (CB) based spatial domain and time domain beam prediction, or to produce non-chronological backtracking (NCB) based spatial domain and time domain beam characteristics predictions (e.g., point-direction, angle of departure (AoD), angle of arrival (AoA), etc.). Such predictions may include joint spatial domain and time domain prediction, including serving beam refinement, link quality (e.g., CQI/PMI) and interference adaptation, beam failure and blockage prediction, and RLF prediction. In some cases, AI/ML-based beam prediction may be used for frequency domain predictions as well. In some examples, AI/ML-based beam prediction may include downsampling.

In some examples, AI/ML-based beam management may include one or more cases for characterization and baseline performance evaluation. For example, a first case may include spatial-domain downlink beam prediction, where beam prediction for a second set “A” of beams may be based on measurement results of a first set “B” of beams. Additionally, or alternatively, a second case may include temporal (e.g., time-domain) downlink beam prediction, where beam prediction for the second set A of beams may be based on historic measurement results of the first set B of beams. In some cases, beams in the second set A and beams in the first set B may be within a same frequency range.

In some examples, the set B may be a subset of the set A, where a number of beams in the set A and the set B may be configured (e.g., in a setting at a UE 115), and where a selection of the beams form the set A for the set B may be determined based on a fixed or random pattern, or by other factors. In some cases, the set A and the set B may be different sets of beams. For example, the set A may include narrow beams (e.g., CSI-RSs), whereas the set B may include wide beams (e.g., SSBs), or vice-versa. In some cases, a number of beams of set A and set B may be determined or configured along with a quasi-colocation (QCL) relation between the two sets of beams. In some examples, set A may be for downlink beam prediction, whereas set B may be for downlink beam measurement. Additionally, or alternatively, codebook and beam types or composition of each set may be specified by one or more configurations.

In some examples, resources for beam management may be defined by one or more parameters or indications. For example, for periodic or semi-periodic transmission of one or more CSI-RSs, a UE 115 may receive a parameter (e.g., “periodicityAndOffset”) defining CSI-RS periodicity and slot offset. In some cases, CSI-RS resources within a set of CSI-RS resources for measurement and transmissions may be configured with a same periodicity, while slot offset may be the same or different for different CSI-RS resources. In some examples, the parameter may be received or configured in for one or more CSI resource sets in a CSI resource configuration (e.g., or one or more “CSI-ResourceSets” in a “CSI-ResoruceConfig”). In some examples, a similar parameter may be received defining periodicity and slot offset for one or more SSBs.

In some cases, a UE 115 may be configured with or indicated a maximum number of resource sets (e.g., for CSI-RS resources) if receiving aperioidic resources, or a single set otherwise (e.g., for semi-persistent or periodic signals). For example, a CSI resource setting for non-zero power CSI-RSs (NZP-CSI-RS) (e.g., a “nzp-CSI-RS-ResourceSetList”) may include a parameter for a maximum number of resource sets (e.g., “maxNrofNZP-CSI-RS-ResourceSetsPerConfig”) based on resource type parameter (e.g., “resourceType”). In some cases, the UE 115 may select a single resource set (e.g., a single NZP-CSI-RS resource set or single SSB resource set) from a set of configured resource sets for aperiodic reports (e.g., an aperiodic CSI report). Otherwise, the number of resource sets may be limited to 1 (e.g., S=1) for periodic and semi-persistent resource settings. In some cases, time domain behavior of reference signal resources (e.g., for CSI-RSs) within a reference signal resource setting may be indicated by the resource type parameter, which may be set to aperioidic, periodic, or semi-persistent.

In some examples, when reporting L1-RSRPs together with SSB resource indicators (SSBRI)/CSI-RS resource indicators (CRI), the SSBRIs/CRIs may be associated with a CMR. For example, if a parameter in a CSI resource or report setting (e.g., “reportQuantity”) indicates RSRP reporting (e.g., “=cri-RSRP”), the reported CRI may be associated with a resource set (e.g., an NZP-CSI-RS resource set) configured at the UE 115 (e.g., for periodic/semi-persistent reporting), or triggered at the UE 115 (e.g., for aperiodic reporting) for the CSI report.

In some cases, a UE 115 may report beam pairs made of beams from two CMR sets. For example, when associated with aperiodic reporting, an RRC parameter may be extended to include two CMR sets, where each CMR set may be configured with corresponding QCL information. When associated with periodic/semi-persistent resource setting, the resource setting may include two CMR sets. In some cases, such settings may include reporting of beam pairs, where each beam pair may include a beam from one CMR set, and a beam from the other CMR set of the two CMR sets. In some cases, a UE 115 may perform differential parameter reporting across all beam groups. For example, the UE 115 may report measurements (e.g., L1-RSRP or other metrics) across all beam groups in a CSI report. In some examples, the beam pairs may be configured by a network entity 105.

The CSI report may include a 1-bit indicator of the CMR set associated with the largest RSRP value in all groups, where the beam with the largest RSRP value may be assumed in the first group of the CSI report. For example, a “0” may indicate a first SSBRI/CRI from a first CMR set, and a “1” may indicate a first SSBRI/CRI from a second CMR set. The report may also include CMR IDs (e.g., SSBRIs and CRIs) across the two CMR sets. For example, the report may include CMR IDs of a first and second CMR of a first beam pair including a strongest CMR (CMR with strongest RSRP), and CMR IDs of a second and third CMR of a second beam pair. Uplink control information (UCI) payload partitioning may include 7 bits for the highest report measurement, where the highest RSRP may be absolute, and 4 bits for all other beam measurements, where RSRPs for other beams may be differential. In some examples, the number of groups may be indicated by a parameter N, where N may equal 2 or more groups, and where the number of beams per group, or pair, may be indicated by M, where M may equal 2. In some cases, the payload size of the CSI report may be fixed based on the reporting of the one or more parameters for the one or more pairs. In some cases, reporting beam pairs in such a manner may not support beam prediction and may only support beam measurements. For example, the one or more parameters (e.g., L1-RSRPs) may be measurements and not predictions, where both CMR sets are measured.

As described herein, the wireless communications system 100 may include enhanced techniques and/or enhanced frameworks for reporting parameters for multiple resource sets. For example, a UE 115 may report one or more parameters (e.g., L1-RSRPs or other parameters) measured or predicted for a first set of resources and a second set of resources. In some cases, reference signals may be transmitted for both sets of resources, or may only be transmitted for the first set of resources. In some examples, reference signals for the second set of resources may be transmitted less frequently than reference signals for the first set of resources. In some examples, the UE 115 may report parameters for the second set of resources, but may not report parameters for the first set of resources. In some cases, when reporting parameters for the second set of resources, reference signals may be transmitted for both sets of resources with different periodicities, or may only be transmitted for the first set of resources. In some examples, one or more parameters or beam characteristics for the first set of resources may be measured, and one or more parameters or beam characteristics for the second set of resources may be predicted based on the measured parameters or characteristics for the first set of resources. In some cases, the UE 115 may perform measurements and predictions using the reference signals.

In some examples, the first set of resources and the second set of resources may represent CMRs, CPRS, or both. In some examples, the second set of resource may represent a virtual set of resources, or may include one or more virtual resources, where no reference signals are transmitted for the second set of resources. In some cases, virtual sets or resources may be nominal resources (e.g., nominal CSI-RS resources), or virtual QCL resources. In some cases, the second set of resources, or the resources in the second set of resources may indicate this lack of transmissions. In some examples, reporting for the described techniques and frameworks may be periodic, semi-persistent, or aperiodic.

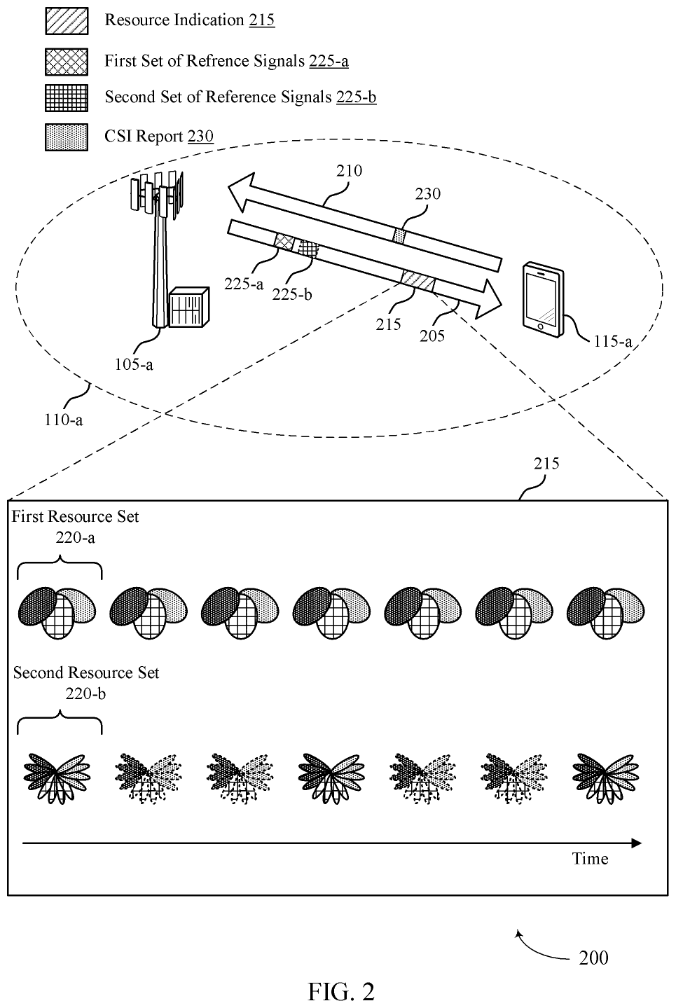

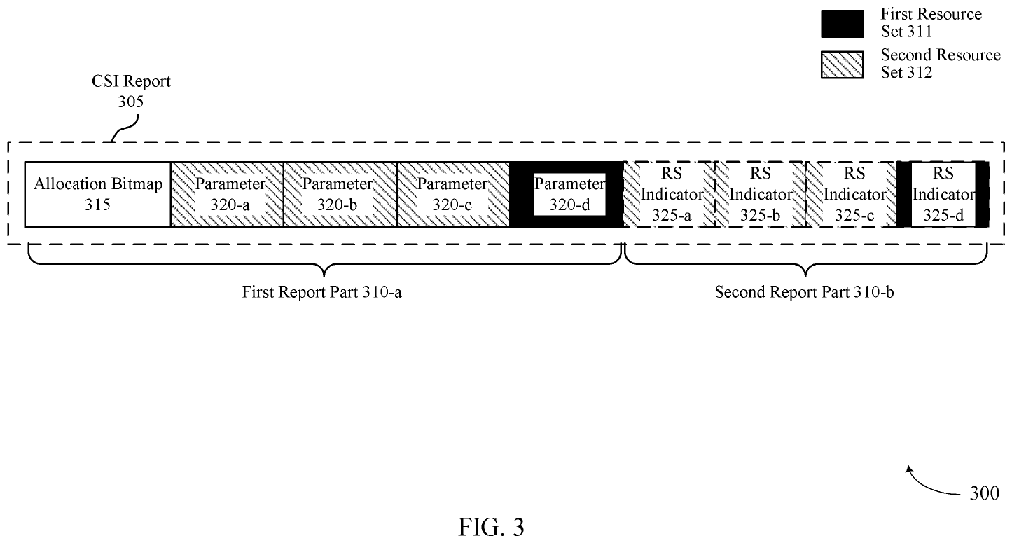

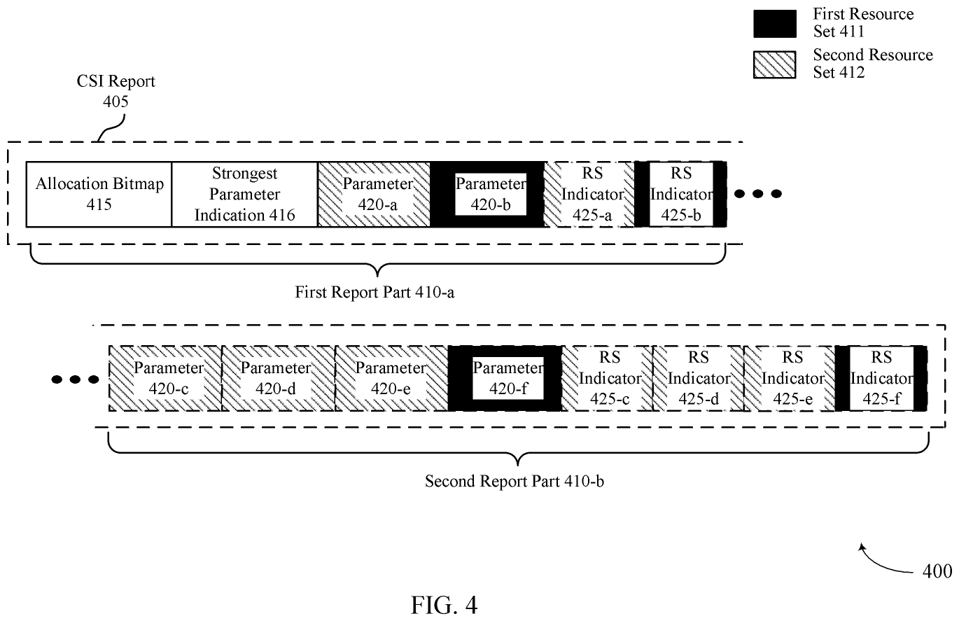

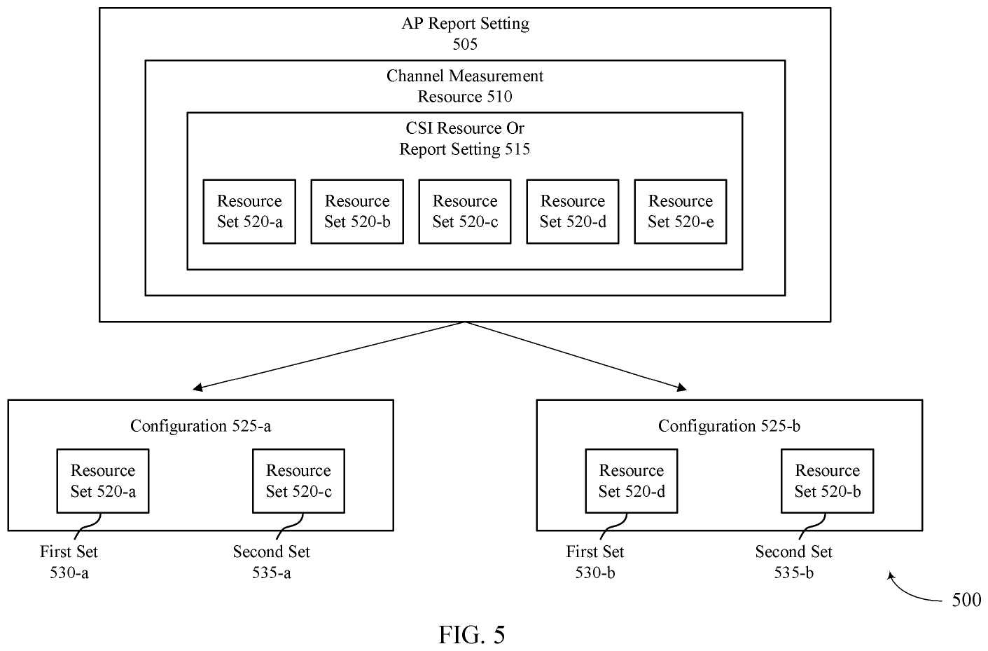

In some examples, the enhanced reporting and allocation frameworks described herein may allow a UE 115 to measure and predict parameters and characteristics by receiving reference signals for each resource set according to different periodicities. A UE 115 may also utilize enhanced reporting and allocation frameworks as described with reference to FIGS. 3 and 4 for reporting parameters and indicators (e.g., CRI/SSBRI) for two or more resource sets in periodic, semi-persistent, and aperiodic reporting. A UE 115 may also include enhanced reporting procedures for aperiodic reporting as described with reference to FIG. 5. In some examples, a UE 115 may include one or more techniques related to virtual sets and virtual resources as described with reference to FIGS. 2-5.

FIG. 2 illustrates an example of a wireless communications system 200 that supports techniques for channel measurement with predictive beam management in accordance with one or more aspects of the present disclosure. In some examples, the wireless communications system 200 may implement, or be implemented by, aspects of the wireless communications system 100. The wireless communications system 200 may include a network entity 105-a with a coverage area 110-a and a UE-115-a, which may represent examples of the network entities 105 with coverage areas 110 and the UEs 115 described with reference to FIG. 1. In some examples, the network entity 105-a may transmit control information, data, or both to the UE 115-a using a downlink communication link 205. Similarly, the UE 115-a may transmit control information, data, or both to the network entity 105-a using an uplink communication link 210.

In some examples, the wireless communications system 200 may support techniques for CSI reporting for multiple resource sets as described with reference to FIG. 1. For example, the network entity 105-a may transmit an indication 215 of multiple resource sets 220. For example, the indication 215 may indicate a first resource set 220-a and second resource set 220-b. In some cases, the indication 215 may be included in a CSI resource or report setting. In some examples, the UE 115-a may perform one or more measurements or predictions for the first resource set 220-a and the second resource set 220-b. For example, after transmitting the indication 215, the network entity 105-a may transmit a first set of reference signals 225-a via the first resource set 220-a and a second set of reference signals 225-b via the second resource set 220-b. In some cases, the two sets of reference signals 225 may be CSI-RSs, SSBs, or any combination thereof. The UE 115-a may receive the first set of reference signals 225-a via the first resource set 220-a and may receive the second set of reference signals 225-b via the second resource set 220-b. In some cases, the UE 115-a may perform one or more measurements or predictions for the resource sets 220 using the respective sets of reference signals 225.

In some examples, the first resource set 220-a may be for measurements, and the second resource set 220-b may be for predictions based on the measurements taken on the first resource set 220-a. For example, the UE 115-a may measure one or more parameters or beam characteristics for the first resource set 220-a using the first set of reference signals 225-a and may predict one or more parameters or beam characteristics for the second resource set 220-b based on the measured parameters and beam characteristics, the second set of reference signals 225-b, or both. In some cases, the resource sets 220 may include one or more reference signal resources. For example, the first resource set 220-a may include one or more NZP-CSI-RS resources or one or more SSB resources as described herein. The second resource set 220-b may similarly include one or more NZP-CSI-RS resources or one or more SSB resources.

In some cases, the resource sets 220 may include one or more periodic or semi-persistent resources that may be measured or used in predictions based on a first periodicity and a second periodicity. For example, the network entity 105-a may transmit the first set of reference signals 225-a corresponding to the first resource set 220-a to the UE 115-a using the first periodicity. Similarly, the network entity 105-a may transmit the second set of reference signals 225-b corresponding to the second resource set 220-b to the UE 115-a using the second periodicity. In some cases, the second periodicity may be the same as the first periodicity, and the two sets 225 of reference signals may be offset or transmitted concurrently as described with reference to FIG. 1. By way of another example, the second periodicity may be different than the first periodicity. For example, the second periodicity may be lower than the first periodicity, where the network entity 105-a may transmit the second set of reference signals 225-b less frequently than the first set of reference signals 225-a (e.g., may transmit at a third of the rate). In some examples, the network entity 105-a may transmit both sets of reference signals 225 at the same periodicity, but the UE 115-a may measure the second set of reference signals 225-b less frequently than the first set of reference signals 225-a.

In some cases, the resource sets 220 may represent one or more aperiodic resources as described with reference to FIG. 5. For example, the UE 115-a may be preconfigured with multiple resource sets 220 by a CSI resource or report setting. The network entity 105-a may transmit a DCI to the UE 115-a to trigger an aperiodic CSI report. In response to the DCI, and based on an aperiodic triggering state configuration, the UE 115-a may select the first resource set 220-a and the second resource set 220-b from the multiple configured resource sets 220 for performing measurements and predictions. In some cases, the network entity 105-a may transmit the sets of reference signals 225, or may refrain from transmitting one or more reference signals.

In some examples, the second resource set 220-b may include one or more virtual resources. For example, the second resource set 220-b may not be associated with any reference signals (e.g., the second set of reference signals 225-b), and the UE 115-a may not expect to receive any signals over the resource set 220-b from the network entity 105-a. In some cases, the UE 115-a may use the second resource set 220-b to determine one or more parameters based on one or more frequency domain or time domain resource patterns.

In some examples, the UE 115-a may transmit a CSI report 230 to the network entity 105-a based on the indication 215, the resource sets 220, the sets of reference signals 225, or any combination thereof. For example, the CSI report 230 may include the one or more measurements or predictions made by the UE 115-a. In some examples, the one or more measurements or predictions may include one or more parameters, where the one or more parameters may include at least one of an L1-RSRP, an L1 signal to interference and noise ratio (L1-SINR), a PMI, a CQI, or a layer indicator (L1). In some examples, the one or more parameters in the report CSI 230 may be associated with both the first resource set 220-a as well as the second resource set 220-b. By way of another example, the one or more parameters may be associated with the second resource set 220-b, but may not be associated with the first resource set 220-a. For example, the UE 115-a may perform one or more measurements on the first resource set 220-a using the first set of reference signals 225-a, and may use these measurements to predict one or more parameters or beam characteristics of the second resource set 220-b, where the UE 115-a may include the one or more predicted parameters or beam characteristics in the CSI report 230.

In some examples, the UE 115-a may report parameters associated with both the first resource set 220-a and the second resource set 220-b in the CSI report 230, where both sets of reference signals 225 may be transmitted to the UE 115-a. For example, the UE 115-a may include one or more parameters (e.g., L1-RSRP, L1-SINR, RI, PMI, CQI, L1, etc.) in the CSI report 230, where the one or more parameters may be based on measurements performed on or predictions for both the first resource set 220-a and the second resource set 220-b using the first set of reference signals 225-a and the second set of reference signals 225-b. In some examples, the second set of reference signals 225-b may have a lower periodicity than the first set of reference signals 225-a, or the UE 115-a may measure the second set of reference signals 225-a and the second resource set 220-b less frequently as described herein. In some examples, the UE 115-a may predict one or more unknown parameters or beam characteristics based on the less frequently transmitted second set of reference signals 225-b (e.g., may predict beams that are skipped compared to the first set of reference signals 225-a).

In some examples, both resource sets 220 may represent sets of CMRs, where both sets may be identified by the UE 115-a from a CSI resource setting or report setting associated with the CSI report 230. For example, the first resource set 220-a may represent a first CMR set, and the second resource set 220-b may represent a second CMR set. In some cases, the CSI report 230 and the corresponding CSI resource setting may include one or more additional fields or flags for beam prediction use cases. For example, a CSI report or resource setting may include a max number of resource sets 220 per configuration if a resource type is aperiodic as described with respect to FIG. 1. The setting may also include a max number of resources if beam prediction is enabled, (e.g., “BeamPrediction” is set to “enabled”). The setting may allow one resource set otherwise. In such examples, if beam prediction is enabled, the UE 115-a may detect multiple resource sets in a CSI resource or report setting. For example, in such a case, the UE 115-a may detect the first resource set 220-a (e.g., including a quantity of SSBs resources) and the second resource set 220-b (e.g., including a quantity of CSI-RS resources). In some examples, the UE 115-a may determine and report a bitmap, one or more parameters, and one or more SSBRIS or CRIs in the CSI report 230 as described in further detail with reference to FIG. 3. Additionally, or alternatively, the network entity 105-a may determine and configure the allocation of the CSI report 230 in a CSI report setting, as described in further detail with reference to FIG. 4.

In some examples, the resource sets 220 may be subsets of a single set of CMRs. For example, the network entity 105-a may include the resource indication 215 in a CSI resource setting transmitted to the UE 115-a for the CSI report 230. The CSI resource setting may thus include subset partitioning for periodic, semi-persistent, and aperiodic reports, for partitioning a single CMR set into the two resource sets 220. Additionally, or alternatively, a MAC-CE may activate semi-persistent CSI reporting or using a semi-persistent resource set for CSI reporting, and may indicate partitioning accordingly. By way of another example, reporting using such partitioning may be configured by an aperiodic CSI triggering state configuration and triggered via DCI, as described with reference to FIG. 5.

In some examples, the resource sets 220 may be configured with different periodicities by a flag in DCI or another signal transmitted to the UE 115-a by the network entity 105-a. For example, the CSI resource setting may include additional fields or flags, where all reference signal resources (e.g., CSI-RS resources) within a set are configured with a same periodicity unless the flag is enabled. For instance, the flag may indicate beam prediction, and if enabled, may allow different periodicities for different types of resources. For example, a CMR in the CSI resource setting may include the first resource set 220-a, which may include SSB resources, and the second resource set 220-b, which may include CSI-RS resources. The two resource sets 220 may thus be configured with different periodicities if the flag indicating beam prediction is enabled. In some cases, both resource sets 220 may include CSI-RS resources, but may be allowed to have different periodicities. In some examples, a slot offset of different resources (e.g., of the first resource set 220-a or the second resource set 220-b) within the CMR may be the same or different.

In some examples, the resource sets 220 may include CMRs as well as new types of channel resources. For example, the first resource set 220-a may include CMR resources, whereas the second resource set 220-b may include CPRs. In some cases, CPRs may be used for predictions of one or more beams or parameters in beam management predictions as described herein. For example, the UE 115-a may predict one or more parameters for the CPRs of the second resource set 220-b based on measurements on the CMRs of the first resource set 220-a. In some cases, a CSI resource setting may include a new indicator for CPRs. By way of another example, CPRs may be a subset of CMRs. In some examples, the first resource set 220-a or the second resource set 220-b may include CMRs, CPRs, interference measurement resources, or any combination thereof. In some cases, the UE 115-a may generate the report 230 for both the CMRs of the first resource set 220-a and the CPRs of the second resource set 220-b, as described with reference to FIG. 3. In some examples, the network entity 105-a may define a makeup of the report 230 in a CRI resource setting for both the CMRs of the first resource set 220-a and the CPRs of the second resource set 220-b as described with reference to FIG. 4. In some examples, the second set of reference signals 225-b may include a lower periodicity due to association with the CPRs of the second resource set 220-b. In some examples, CPRs may be defined at the CSI resource setting or CSI report setting level.

In some examples, the UE 115-a may report parameters associated with both the first resource set 220-a and the second resource set 220-b in the CSI report 230, where the network entity 105-a may transmit the first set of reference signals 225-a, but may refrain from transmitting the second set of reference signals 225-b. For example, the second resource set 220-b may include a virtual set of resources or may include one or more virtual resources, where the UE 115-a may perform one or more measurements and predictions based on the first set of resources 220-a, the second virtual set of resources 220-b or virtual resources in the second resource set 220-b, and the first set of reference signals 225-a.

In some cases, both resource sets 220 may include CMRs as described herein. In some examples, the second resource set 220-b may be based on an enhanced resource set configuration (e.g., enhanced CSI-RS or enhanced SSB), where the enhanced resource set configuration may indicate a lack of transmissions associated with the resource. In some examples, the indication may be a flag indicating whether or not the second set of reference signals 225-b associated with the second resource set 220-b will be transmitted. For example, the flag (e.g., a “NotTransmitted” flag defined in a “CSI-SSB-ResourceSet” or “NZP-CSI-RS-ResourceSet”) may be set to either “enabled” or “disabled” based on whether or not the network entity 105-a is to transmit the second set of reference signals 225-a. In such an example, the second resource set 220-b may represent a virtual resource set. In some examples, the virtual second resource set 220-b may include one or more CSI-RS or SSB resources. In some examples, the UE 115-b may use the virtual second resource set 220-b to determine one or more parameters (e.g., L1-RSRP) based on frequency domain or time domain resource patterns of the second resource set 220-b. In some cases, the UE 115-a may determine the configuration of the CSI report 230 as described with respect to FIG. 3, or the network entity 105-a may determine the configuration of the CSI report 230 in a CSI resource setting for the CSI report 230, as described with reference to FIG. 4.

In some examples, both resource sets 220 may be subsets of a single CMR set, as described herein. In some cases, the second subset, or second resource set 220-b, may be based on an enhanced resource setting indicating a lack of reference signal transmissions and may be used by the UE 115-a for determining parameters based on resource patterns as described herein. In some examples, the resources of the second resource set 220-b may be based on a new type of virtual CSI-RS resource, where each resource (e.g., “Virtual-NZP-CSI-RS-Resource”) may include a flag indicating whether or not the second set of reference signals 225-b associated with the second resource set 220-b will be transmitted. For example, the flag (e.g., “NotTransmitted”) may be set to either “enabled” or “disabled.” In some examples, remaining information elements including such resources may be identical with other CSI-RS resources and may not be virtual type resources, for example, for CSI-RS resources (e.g., “NZP-CSI-RS-Resource”)). In some examples, the CMR including the first and second resource sets 220 may include an identifier indication at the set level that the second resource set 220-b is a virtual set of resources, where the second resource set 220-b may be CSI-RS or SSB resources.

In some examples, the second virtual resource set 220-b may include one or more CPRs as described herein. In some examples, a flag on the resource level or the resource set level may indicate that second set of reference signals 225-b for the second resource set 220-b are not transmitted. For example, dedicated sub-IEs may indicate at a set level or a resource level a lack of use of the resource set 220-b or the resources in the resource set 220-b. In some examples, the UE 115-a may determine the configuration of the CSI report 230, as described with respect to FIG. 3, or the network entity 105-a may determine the configuration of the CSI report 230 in a CRI resource setting for the CSI report 230, as described with reference to FIG. 4.

In some examples, the UE 115-a may include measured or predicted parameters for the second resource set 220-b in the CSI report 230, but may refrain from including parameters for the first resource set 220-a, where both sets of reference signals 225 may be transmitted to the UE 115-a. In some cases, the second set of resources 220-b may include a longer periodicity than the first set of resources 220-a for measurements and for transmitting the sets of reference signals 225 as described herein. Both resource sets 220 may include CMRs, or may include CMRs and CPRs as described herein. In some cases, report configurations described in FIGS. 3 and 4 may not be used as allocation problems are avoided based on all resources being used for prediction. In some examples, both resource sets 220 may be subsets of a single CMR set as described herein, where a quantity of bits in the report 230 for feeding back CRI may be determined based on a quantity of resources included in the second resource set 220-b. In some cases, for subsets of a single CMR, the UE 115-a or the network entity 105-a may determine an allocation for the report 230, as described with respect to FIGS. 3 and 4.

In some examples, the UE 115-a may include measured or predicted parameters or characteristics for the second resource set 220-b in the CSI report 230, but may refrain from including parameters or characteristics for the first resource set 220-a, where the second set of reference signals 225-b may not be transmitted to the UE 115-a. For example, the second resource set 220-b may include a virtual set of resources or one or more virtual resources as described herein. In some cases, both resource sets 220 may include CMRs, or may include CMRs and CPRs as described herein. In some examples, report configurations described in FIGS. 3 and 4 may not be used. In some examples, both resource sets 220 may be subsets of a single CMR set as described herein, where a quantity of bits in the report 230 for feeding back CRI may be determined based on a quantity of resources included in the second resource set 220-b. In some cases, for subsets of a single CMR, the UE 115-a or the network entity 105-a may determine an allocation for the report 230, as described with respect to FIGS. 3 and 4.

In some examples, a CSI report setting or CSI resource setting may be designed to support all possible combinations of transmissions of sets of reference signals 225 and reporting for each resource set 220 for multiple CMR sets, subsets of a single CMR set, or CMR and CPR sets. In some cases, for periodic CSI reports, one or more of the techniques described herein may be preconfigured using RRC signaling. For example, the network entity 105-a may transmit an RRC signal to the UE 115-a including a CSI report setting or CSI resource setting associated with the CSI report 230, which may be a periodic CSI report. In some cases, for semi-persistent CSI reports, one or more of the techniques described herein may be indicated using MAC-CE signaling when activating a considered semi-persistent CSI report. For example, the network entity 105-a may transmit a MAC-CE to the UE 115-a indicating whether report parameters are be based on only the second resource set 220-b or on both resource sets 220, and whether the second set of reference signals 225-b are to be transmitted or not (e.g., whether the second resource set 220-b includes a virtual set of resources (or virtual resources) or not).

In some examples, for aperiodic reports, one or more of the techniques described herein may be preconfigured by the aperiodic triggering state configurations associated with the aperiodic CSI reports, and may be indicated via DCI when triggering an aperioidic CSI report. For example, the UE 115-a may be preconfigured with an aperiodic triggering state configuration that may indicate whether report parameters are be based on only the second resource set 220-b or on both resource sets 220, whether the second set of reference signals 225-b are transmitted or not (e.g., whether the second resource set 220-b includes a virtual set of resources, or virtual resources or not), and which detailed type of resources (e.g., CSI-RS, SSB) may be associated with the CSI report 230.

FIG. 3 illustrates an example of a report diagram 300 that supports techniques for channel measurement with predictive beam management in accordance with one or more aspects of the present disclosure. The report diagram 300 may include a CSI report 305 that is configured by a UE 115 as described with reference to FIGS. 1 and 2. For example, a UE 115 may perform one or more measurements and predictions for one or more reference signal resource sets, and may determine, based on one or more configurations or signals as described herein, to report the allocations shown in FIG. 3 in the CSI report 305. The CSI report 305 may thus include a first report part 310-a, a second report part 310-b, an allocation bitmap 315, one or more parameters 320, and one or more reference signal resource indicators 325.

In some examples, a UE 115 may report one or more highest parameters for multiple sets of reference signal resources. For example, the UE 115 may report X highest L1-RSRPs for N₁ SSBs for a first resource set 311 (e.g., for the first resource set 220-a described in FIG. 2, which may be a CMR or CPR) and for N₂ CSI-RSs for a second resource set 312 (e.g., for the second resource set 220-b described in FIG. 2, which may also be a CMR or CPR). In some cases, if X=4, the parameters 320-a, 320-b, and 320-c may represent the three highest L1-RSRPs and may be associated with the second resource set 312, whereas parameter 320-d may represent the fourth highest L1-RSRP and may be associated with the first resource set 311. In some cases, the SSBs may be transmitted (e.g., by a network entity 105) at a higher periodicity of 20 ms, whereas the CSI-RSs may be transmitted at a lower periodicity of 320 ms, where the reporting periodicity of the UE 115 may be 20 ms as well. In some examples, the highest parameter, the parameter 320-a, may be represented by 7-bits and may be absolute, whereas the remaining parameters 320 may be represented by 4-bits and may be differential.

In some examples, the UE 115 may include respective reference signal resource indicators 325-a, 325-b, 325-c, and 325-c to indicate the reference signals on which the parameters 320 are based. For example, the UE 115 may include the reference signal resource indicators 325-a, 325-b, and 325-c to indicate respective CRIs for the CSI-RSs from the second resource set 312, where the parameters 320-a, 320-b, and 320-c may be based on the CRIs 325-a, 325-b, and 325-c, respectively. The report 305 may also include the fourth reference signal resource indicator 325-d to indicate a respective SSBRI for the SSB from the first resource set 311, on which the parameter 320-d is based.

In some examples, if the number of resources or reference signals N₁ of the first resource set 311 is equal to the number of resources or reference signals N₂ of the second resource set 312, the UE 115 may transmit a single part CSI report. For example, the UE 115 may report the respective SSBRIs and CRIs using log₂ N₁ bits, and the CSI report 305 may include the report part 310-a and the report part 310-b as a single-part CSI report based on the fixed size. In some examples, if the number of resources or reference signals N₁ of the first resource set 311 is not equal to the number of resources or reference signals N₂ of the second resource set 312, the UE 115 may transmit a two part CSI report. For example, the UE 115 may report an SSBRI using log₂ N₁ bits and each CRI using log₂ N₂ bits. The UE 115 may then include the report part 310-a as a first part with a fixed size, and add on the report part 310-b as a second part with a variable size payload.

In some examples, the UE 115 may also indicate which resource set each SSBRI or CRI is associated with. For example, the UE 115 may include the allocation bitmap 315 to indicate which resource set the top X reported parameters 320 are associated with. For example, for the 4 reported reference signal resource indicators 325-a through 325-d, the allocation bitmap 315 may include 4 bits: “1, 1, 1, 0”. In some cases, “1” may indicate that a reference signal resource indicator 325 is associated with the second resource set 312, and “0” may indicate that a reference signal resource indicator 325 is associated with the first resource set 311. Thus, the allocation bitmap 315 may indicate that the first three reference signal resource indicators 325-a through 325-c are associated with the second resource set 312, and that the fourth reference signal resource indicator 325-d is associated with the first resource set 311.

FIG. 4 illustrates an example of a report diagram 400 that supports techniques for channel measurement with predictive beam management in accordance with one or more aspects of the present disclosure. The report diagram 400 may include a CSI report 405 that is configured by a network entity 105 as described with reference to FIG. 2. For example, a network entity 105 may configure multiple resources (e.g., CMRs or CPRs) for a first resource set 411 and a second resource set 412 in a CSI resource setting or report setting. In some examples, the CSI report payload size may be fixed, and the setting or another parameter or configuration may indicate to a UE 115 to report whichever of the two sets is associated with a strongest parameter. The CSI report 305 may thus include a report part 410-a, a report part 410-b, an allocation bitmap 415, a strongest parameter indicator 416, one or more parameters 420, and one or more reference signal resource indicators 425.

In some examples, the network entity 105 may indicate in the CSI report setting (or in a CSI resource setting) to address at least N₁ resources in the first resource set 411 and at least N₂ resources in the second resource set 412. For example, the CSI report setting may indicate to address at least N₁ CMRs and at least N₂ CMRs if the first and second resource sets both include CMRs, or at least N₁ CMRs and at least N₂ CPRs if the second resource set 412 includes CPRs as described herein. The CSI report may similarly indicate to address other resource types according to the types of resource sets or resources included in the first resource set 411 and the second resource set 412. In some examples, the UE 115 may determine and report allocations among the remaining addressed resources (e.g., for any remaining CMRs, CPRs, or other resources not addressed by the network entity 105 in the CSI report or resource setting).

For example, the network entity 105 may configure a CSI report setting or resource setting so that N₁ and N₂ may both equal 1, indicating to address at least one resource in the first resource set 411 and at least one resource in the second resource set 412. The report 405 may thus include the parameter 420-a and the reference signal resource indicator 425-a associated with the second resource set 412, and the parameter 420-b and the reference signal resource indicator 425-b associated with the first resource set 411. The report 405 may also include the strongest parameter indicator 416, where the UE 115 may use the strongest parameter indicator 416 to indicate to the network entity 105 an order of the resource sets according to highest parameter 420 value (e.g., highest L1-RSRP). For example, the strongest parameter indicator 416 may include a one bit indicator set to either “0” or a “1”, where “0” may correspond to the second resource set 412, and where “1” may correspond to the first resource set 411.

In some examples, the strongest parameter indicator 416, the parameters 420-a and 420-b, and the reference signal resource indicators 425-a and 425-b may be included in the first report part 410-a as part of a one-part CSI report with a fixed payload size as described herein. By way of another example, the UE 115 may include a two-part CSI report, where the CSI report 405 may include both the first report part 410-a, and a second report part 410-b. For example, the UE 115 may include the strongest parameter indicator 416, the parameters 420-a and 420-b, the reference signal resource indicators 425-a and 425-b, as well as the allocation bitmap 415 in the first report part 420-a, where the allocation bitmap 415 may indicate reported allocations of remaining addressed resources in the second report part 410-b. In some examples, the first report part 410-a may include a fixed payload size as configured in the CSI report setting by the network entity 105, whereas the second report part 410-b may include a variable payload size as determined by the UE 115. In some cases, the fixed payload size of the first report part 410-a may result in a greater reliability compared to the second report part 410-b with variable payload size.

In some examples, the UE 115 may determine to allocate a number of total resources, where the UE may allocate a number of remaining resources after the CSI report setting resources are allocated in the first report part 410-a. For example, the UE 115 may allocate a total number of X=6 resources, and may indicate in the allocation bitmap 415 four remaining resources after allocating the first two in the first report part 410-a according to a CSI report setting. In some examples, the UE 115 may include parameters 420-c, 420-d, 420-e, and 420-f along with corresponding reference signal resource indicators 425-c, 425-d, 425-e, and 425-f in the second report part 410-b. The parameters 420-c through 420-e and the reference signal resource indicators 425-c through 425-e may correspond to resources from the second resource set 412, and the parameter 420-f and the corresponding reference signal resource indicator 425-f may correspond to a resource from the first resource set 411. The allocation bitmap 415 may also include four bits to indicate the four additional allocated resources, and may include the bits “1, 1, 1, 0”. In some examples, the parameters 420 in the first report part 410-a and the second report part 410-b may be in order of highest parameter (e.g., highest L1-RSRP value), where the parameter 420-a may be the highest parameter.

In some cases, the parameters 420 may be any measured or predicted parameter or beam characteristic as described herein (e.g., L1-RSRP, L1-SINR, PMI, CQI, LI, etc.). For example, the parameters 420 may be based on SSBs, CSI-RSs, or other reference signals corresponding to the first resource set 411 and the second resource set 412. In some examples, the parameters 420 in the second report part 410-b may include a fixed payload size, whereas the reference signal resource indicators 425 may include a variable payload size. In some cases, the CSI report 405 may include any other number of report parts 410, which may include any variation of fixed and variable payload sizes for each portion of each report part 410. Additionally, or alternatively, the UE 115 may indicate or recommend the resource allocations of the CSI report 405 through MAC-CE or UCI signaling.

FIG. 5 illustrates an example of an aperiodic report triggering process 500 that supports techniques for channel measurement with predictive beam management in accordance with one or more aspects of the present disclosure. For example, a UE 115 may be configured (e.g., via RRC signaling) with an aperiodic report setting 505. The aperiodic report setting 505 may include a CMR 510, which may include a CSI resource or report setting 515. The CSI resource or report setting 515 may include one or more resource sets 520. For example, the CSI resource setting 515 may include resource sets 520-a, 520-b, 520-c, 520-d, and 520-e. In some examples, the CSI resource setting 515 may be a CSI resource setting or a CSI report setting as described herein with respect to FIGS. 1-4.

In some examples, the UE 115 may perform aperiodic CSI reporting. For example, the UE 115 may be triggered aperiodically via DCI to transmit CSI reports as described herein. According to an aperiodic CSI triggering state configuration, the UE 115, when triggered, may select one or more resource sets 520 from the CSI resource or report setting 515 for a configuration 525. For example, the UE 115 may select the resource set 520-a as a first set 530-a and the resource set 520-c as a second set 535-a for a configuration 525-a. Additionally, or alternatively, the UE 115 may select the resource set 520-d as a first set 530-b and the resource set 520-b as a second set 535-b for a configuration 525-b. In some examples, a resource set 520 selected as a first set 530 may represent a first set of resources as described herein (e.g., a first resource set 311 or 411 as described with reference to FIGS. 3 and 4) and a resource set 520 chosen as a second set 535 may represent a second set of resources as described herein (e.g., a second resource set 312 or 412 as described with reference to FIGS. 3 and 4). In some examples, the second sets 535 may indicate transmission or no transmission of reference signals as described herein.

In some examples, the UE 115 may select the first set 530-a and the second set 535-a according to the aperiodic CSI triggering state configuration, where the configuration may indicate to select any of the resource sets 520 if the CSI resource or report setting 515 includes CMR sets and does not include CPR sets. For example, the resource sets 520 may represent CMR sets as described herein, and the UE 115 may select the first set 530-a as a first CMR set and the may select the second set 535-a as a second CMR set. In some cases, the aperiodic CSI triggering state configuration may indicate to select CMR sets from the CSI resource or report setting 515 if the setting 515 includes one or more CMR sets, CPR sets, and other types of resource sets. For example, the resource sets 520 may include a mixture of CMR sets and CPR sets, where the resource set 520-e may represent a CPR set and the resource sets 520-a and 520-c may both be CMR sets. The UE 115 may select the resource sets 520-a and 520-c for the configuration 525-a based on the aperiodic CSI triggering state configuration.

In some examples, the configuration may indicate to select a CMR set from the CSI resource or report setting 515 as the first set 530-b and a CPR set from the CSI resource or report setting 515 as the second set 535-b. For example, the resource sets 520 may represent CMR sets and CPR sets as described herein, and the UE 115 may select the first set 530-b and as a CMR set, where the resource set 520-d may be a CMR set, and may select the second set 535-b as a CPR set, where the resource set 520-b may be a CPR set. In some examples, the UE 115 may be select the first set 530-b and the second set 535-b according to the aperiodic CSI triggering state configuration.

In some examples, the UE 115 may select one or more resource sets 520 for one or more configurations 525, where the UE 115 may report one or more measured or predicted parameters and characteristics for the first sets 530 and the second sets 535, or may report only parameters and characteristics for the second sets 535 as described with reference to FIG. 2. In some examples, the resource sets 520 or resources in the resource sets 520 may indicate a lack of reference signal transmissions, and may represent one or more virtual resource sets or virtual resources as described with reference to FIG. 2. In some examples, the UE 115 may include the parameters or characteristics in a report configured by the UE 115 or the network entity 105 as described with reference to FIGS. 3 and 4, where the report may be configured according to a CSI resource or report setting (e.g., the CSI resource or report setting 515). In some examples, the CSI resource or report setting 515 may indicate the inclusion of one or more CMRs, CPRs, or both.

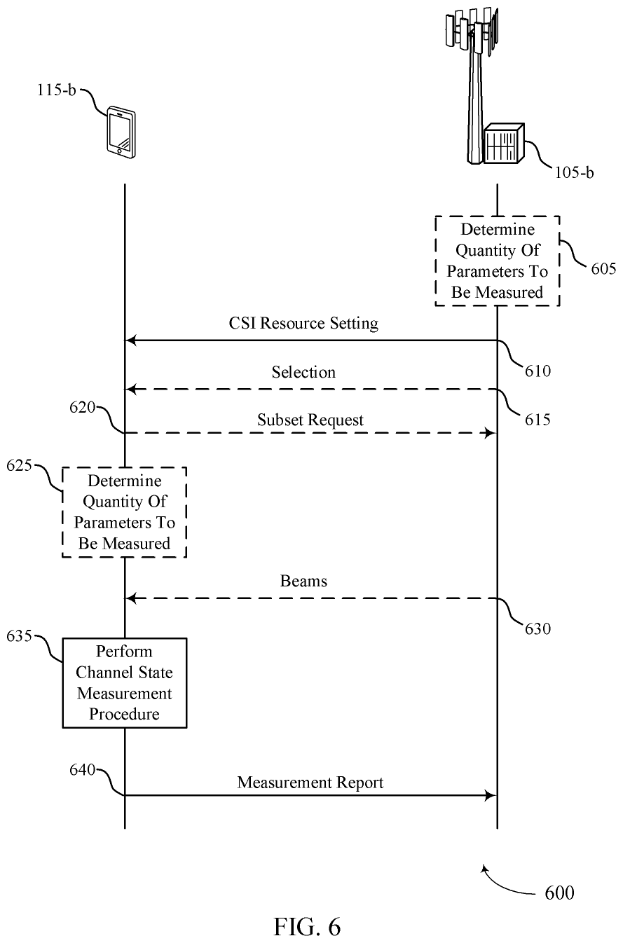

FIG. 6 illustrates an example of a process flow 600 that supports techniques for channel measurement with predictive beam management in accordance with one or more aspects of the present disclosure. The process flow 600 may be implemented by aspects of the wireless communications systems 100 or 200, the report diagrams 300 or 400, or the aperiodic report triggering process 500. For example, the process flow 600 may illustrate communication between a UE 115-b and a network entity 105-b, which may be examples of corresponding devices described herein, including with reference to FIGS. 1 through 5.

In the following description of the process flow 600, the operations may be performed in a different order than the order shown. Specific operations also may be left out of the process flow 600, or other operations may be added to the process flow 600. Further, although some operations or signaling may be shown to occur at different times for discussion purposes, these operations may actually occur at the same time.

At 605, the network entity 105-b may optionally determine a quantity of channel parameters to be measured for a set of CMRs and a set of CPRs.

At 610, the network entity 105-b may transmit, and the UE 115-b may receive, a CSI resource setting indicating the set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. In some examples, the CSI resource setting may indicate that the set of nominal resources includes the set of CPRs. In some cases, the network entity 105-b may indicate the quantity of channel parameters in the CSI resource setting or via another transmission to the UE 115.

In some examples, the CSI resource setting associated with the measurement report may indicate that the set of CMRs includes a first subset of channel resources and the set of nominal resources includes a second subset of the channel resources. In some cases, the CSI resource setting may include a control signal indicating a partitioning between channel resources, wherein the set of CMRs includes the first subset of channel resources and the set of nominal resources includes the second subset of the channel resources in accordance with the partitioning. In some cases, the control signal may include at least one of a MAC-CE activating a semi-persistent CSI report, a MAC-CE activating a semi-persistent CSI resource set, an aperiodic CSI triggering state configuration, a DCI, or any combination thereof. In some examples, the second subset of the channel resources is not indicated by the network entity.

In some examples, the set of CMRs may be associated with a first set of beams and the set of nominal resources may be associated with a second set of beams. In some cases, the set of nominal resources may be based on an enhanced CSI-RS resource set configuration or a SSB resource set configuration. In some examples, a periodicity for the set of CMRs (e.g., the first periodicity) may be longer than a periodicity for the set of nominal resources (e.g., the second periodicity).

In some examples, the network entity 105-b may transmit, and the UE 115-b may receive, a request to perform the channel state measurement procedure based on the set of CMRs in accordance with a first frequency and based on the set of nominal resources in accordance with a second frequency different from the first frequency. In some cases, the request may be indicated in the CSI resource setting or via another transmission to the UE 115.

At 615, the network entity 105-b may optionally transmit, and the UE 115-b may optionally receive, a selection of one of the set of CMRs or the set of nominal resources for the measurement report. In some examples, the selection may be included in the CSI resource setting transmitted at 610.

At 620, the UE 115-b may optionally transmit, and the network entity 105-b may optionally receive, a request to use a subset of the set of CMRs and a subset of the set of nominal resources in performing the channel state measurement procedure. In some examples, the network entity 105-b may respond by transmitting an indication of whether to use the requested subsets or not.

At 625, the UE 115-b may optionally determine the quantity of channel parameters to be measured for the set of CMRs and the set of CPRs.

At 630, the network entity 105-b may optionally transmit, and the UE 115-b may optionally receive, the first set of beams and the second set of beams. In some examples, the network entity 105-b may refrain from transmitting the second set of beams. In some cases, the first set of beams and the second set of beams may include one or more CSI-RSs or SSBs as described herein with reference to FIGS. 1-5.

At 635, the UE 115-b may perform the channel state measurement procedure based on the set of CMRs and the set of nominal resources. In some examples, the UE 115-b may perform the channel state measurement procedure using a subset of the set of CMRs and a subset of the set of nominal resources based on receiving the CSI resource setting. In some examples, the subsets may be the same as the subsets requested for measurement at 620. In some cases, the UE 115-b may perform the channel state measurement procedure using the first set of beams and the second set of beams, one or more CSI-RSs, one or more SSBs, or any combination thereof as described herein with reference to FIGS. 1-5.

At 640, the UE 115-b may transmit, and the network entity 105-b may receive, the measurement report associated with the set of CMRs, or the set of nominal resources, or any combination thereof. In some examples, the measurement report may include one or more channel measurement parameters associated with the set of CMRs or one or more channel prediction parameters associated with the set of CPRs. In some cases, the measurement report may include a set of channel parameters associated with the set of CMRs and the set of CPRs based on the quantity of channel parameters determined at the UE 115-b or the network entity 105-b. In some examples, the measurement report may include at least one of a periodic CSI report, a semi-persistent CSI report, an aperiodic CSI report, or any combination thereof. In some examples, transmitting the measurement report may be based on the selection transmitted by the network entity 105-b, and received at the UE 115-b, at 615.

In some examples, the UE 115-b may transmit, and the network entity 105-b may receive (e.g., in the measurement report), a bitmap indicating the set of channel measurement parameters associated with the set of CMRs and the set of channel prediction parameters associated with the set of CPRs. In some cases, the UE 115-b may transmit a set of bits including an indication of the set of channel measurement parameters and the set of channel prediction parameters, where a quantity of the set of channel measurement parameters is equal to a quantity of the set of channel prediction parameters. In some examples, the UE 115-b may transmit the set of channel measurement parameters and the set of channel prediction parameters, where the measurement report may include a single-part CSI report.

In some examples, the UE 115-b may transmit, and the network entity 105-b may receive (e.g., in the measurement report), a first set of bits including an indication of the set of channel measurement parameters and a second set of bits including an indication of the set of channel prediction parameters, where a quantity of the set of channel measurement parameters is different from a quantity of the set of channel prediction parameters. In some cases, the UE 115-b may transmit (e.g., in the measurement report) the set of channel measurement parameters and the set of channel prediction parameters, where the measurement report may include a two-part CSI report.

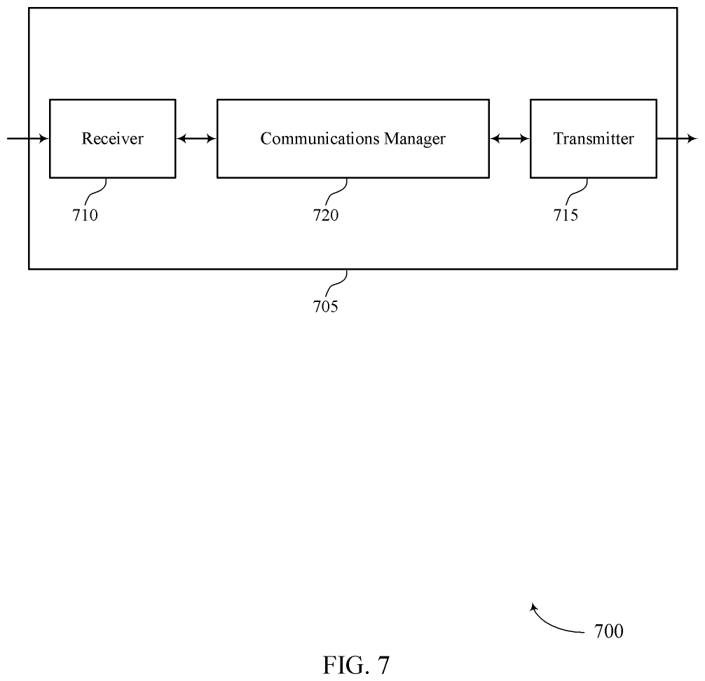

FIG. 7 shows a block diagram 700 of a device 705 that supports techniques for channel measurement with predictive beam management in accordance with one or more aspects of the present disclosure. The device 705 may be an example of aspects of a UE 115 as described herein. The device 705 may include a receiver 710, a transmitter 715, and a communications manager 720. The device 705 may also include a processor (not shown). Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for channel measurement with predictive beam management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for channel measurement with predictive beam management). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for channel measurement with predictive beam management as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 may be configured as or otherwise support a means for receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The communications manager 720 may be configured as or otherwise support a means for performing the channel state measurement procedure based on the set of CMRs and the set of nominal resources. The communications manager 720 may be configured as or otherwise support a means for transmitting a measurement report associated with the set of CMRs, or the set of nominal resources, or any combination thereof.

By including or configuring the communications manager 720 in accordance with examples as described herein, the device 705 (e.g., a processor controlling or otherwise coupled with the receiver 710, the transmitter 715, the communications manager 720, or any combination thereof) may support techniques for reduced processing, reduced power consumption, and more efficient utilization of communication resources.

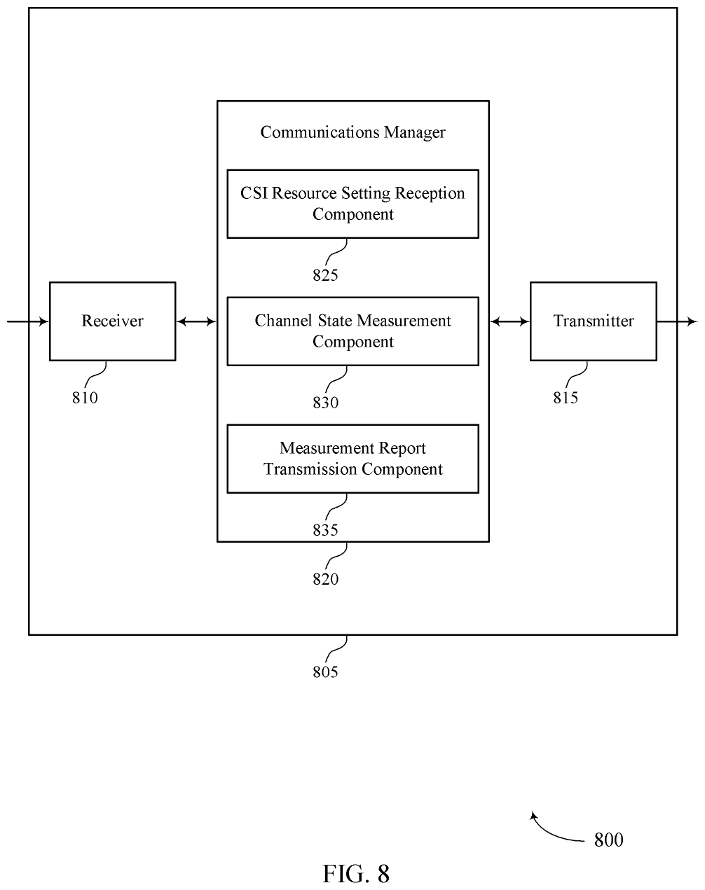

FIG. 8 shows a block diagram 800 of a device 805 that supports techniques for channel measurement with predictive beam management in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor (not shown). Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for channel measurement with predictive beam management). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for channel measurement with predictive beam management). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for channel measurement with predictive beam management as described herein. For example, the communications manager 820 may include a CSI resource setting reception component 825, a channel state measurement component 830, a measurement report transmission component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The CSI resource setting reception component 825 may be configured as or otherwise support a means for receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The channel state measurement component 830 may be configured as or otherwise support a means for performing the channel state measurement procedure based on the set of CMRs and the set of nominal resources. The measurement report transmission component 835 may be configured as or otherwise support a means for transmitting a measurement report associated with the set of CMRs, or the set of nominal resources, or any combination thereof.

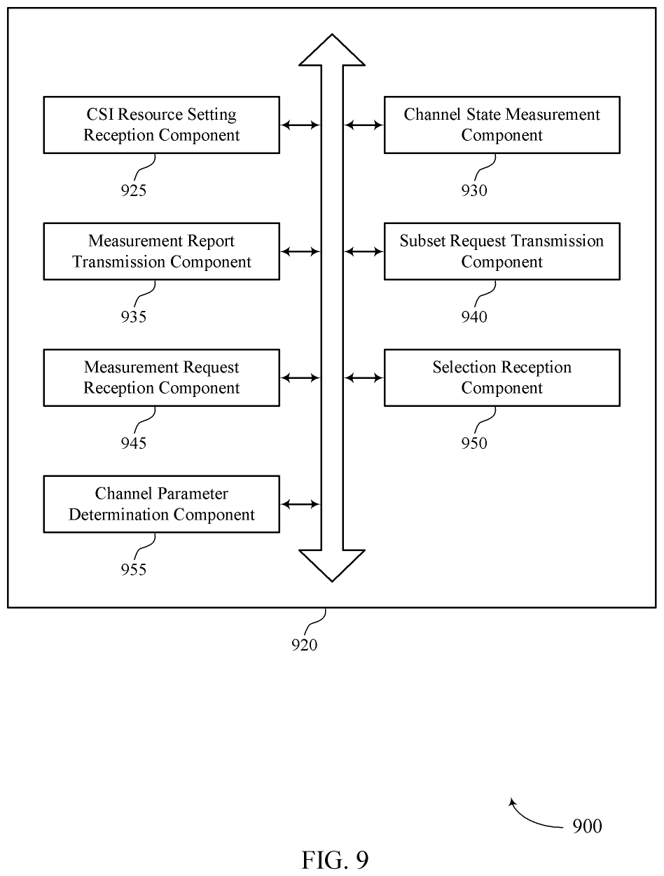

FIG. 9 shows a block diagram 900 of a communications manager 920 that supports techniques for channel measurement with predictive beam management in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for channel measurement with predictive beam management as described herein. For example, the communications manager 920 may include a CSI resource setting reception component 925, a channel state measurement component 930, a measurement report transmission component 935, a subset request transmission component 940, a measurement request reception component 945, a selection reception component 950, a channel parameter determination component 955, or any combination thereof. Each of these components may communicate, directly or indirectly, with one another (e.g., via one or more buses).

The communications manager 920 may support wireless communication at a UE in accordance with examples as disclosed herein. The CSI resource setting reception component 925 may be configured as or otherwise support a means for receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The channel state measurement component 930 may be configured as or otherwise support a means for performing the channel state measurement procedure based on the set of CMRs and the set of nominal resources. The measurement report transmission component 935 may be configured as or otherwise support a means for transmitting a measurement report associated with the set of CMRs, or the set of nominal resources, or any combination thereof.

In some examples, to support receiving the CSI resource setting, the CSI resource setting reception component 925 may be configured as or otherwise support a means for receiving the CSI resource setting indicating that the set of nominal resources includes a set of CPRs.

In some examples, the measurement report transmission component 935 may be configured as or otherwise support a means for transmitting a channel measurement parameter associated with the set of CMRs and a channel prediction parameter associated with the set of CPRs.

In some examples, the channel parameter determination component 955 may be configured as or otherwise support a means for determining a quantity of channel parameters to be measured for the set of CMRs and the set of CPRs. In some examples, the measurement report transmission component 935 may be configured as or otherwise support a means for transmitting a set of channel parameters associated with the set of CMRs and the set of CPRs based on the quantity of channel parameters.

In some examples, the measurement report transmission component 935 may be configured as or otherwise support a means for transmitting a bitmap indicating a set of channel measurement parameters associated with the set of CMRs and a set of channel prediction parameters associated with the set of CPRs.

In some examples, the measurement report transmission component 935 may be configured as or otherwise support a means for transmitting a set of bits including an indication of a set of channel measurement parameters associated with the set of CMRs and a set of channel prediction parameters associated with the set of CPRs, where a quantity of the set of channel measurement parameters is equal to a quantity of the set of channel prediction parameters. In some examples, the measurement report transmission component 935 may be configured as or otherwise support a means for transmitting the set of channel measurement parameters and the set of channel prediction parameters, where the measurement report includes a single-part CSI report.

In some examples, the measurement report transmission component 935 may be configured as or otherwise support a means for transmitting a first set of bits including an indication of a set of channel measurement parameters associated with the set of CMRs and a second set of bits including an indication of a set of channel prediction parameters associated with the set of CPRs, where a quantity of the set of channel measurement parameters is different from a quantity of the set of channel prediction parameters. In some examples, the measurement report transmission component 935 may be configured as or otherwise support a means for transmitting the set of channel measurement parameters and the set of channel prediction parameters, where the measurement report includes a two-part CSI report.

In some examples, to support performing the channel state measurement procedure, the channel state measurement component 930 may be configured as or otherwise support a means for performing the channel state measurement procedure using a subset of the set of CMRs and a subset of the set of nominal resources based on receiving the CSI resource setting.

In some examples, the subset request transmission component 940 may be configured as or otherwise support a means for transmitting, to the network entity, a request to use a subset of the set of CMRs and a subset of the set of nominal resources in performing the channel state measurement procedure.

In some examples, to support receiving the CSI resource setting, the CSI resource setting reception component 925 may be configured as or otherwise support a means for receiving the CSI resource setting associated with the measurement report indicating that the set of CMRs includes a first subset of channel resources and the set of nominal resources includes a second subset of the channel resources.

In some examples, to support receiving the CSI resource setting, the CSI resource setting reception component 925 may be configured as or otherwise support a means for receiving a control signal indicating a partitioning between channel resources, where the set of CMRs includes a first subset of channel resources and the set of nominal resources includes a second subset of the channel resources in accordance with the partitioning.

In some examples, the control signal includes at least one of a medium access control (MAC) control element activating a semi-persistent CSI report, a MAC control element activating a semi-persistent CSI resource set, an aperiodic CSI triggering state configuration, a downlink control information, or any combination thereof.

In some examples, the set of CMRs is associated with a first set of beams and the set of nominal resources is associated with a second set of beams. In some examples, the set of nominal resources is based on an enhanced CSI reference signal resource set configuration or a synchronization signal block resource set configuration.

In some examples, to support receiving the CSI resource setting, the CSI resource setting reception component 925 may be configured as or otherwise support a means for receiving the CSI resource setting indicating that the set of CMRs includes a first subset of channel resources and the set of nominal resources includes a second subset of the channel resources, where the second subset of the channel resources is not indicated by the network entity.

In some examples, the measurement request reception component 945 may be configured as or otherwise support a means for receiving a request to perform the channel state measurement procedure based on the set of CMRs in accordance with a first frequency and based on the set of nominal resources in accordance with a second frequency different from the first frequency.

In some examples, a periodicity for the set of CMRs is longer than a periodicity for the set of nominal resources. In some examples, the selection reception component 950 may be configured as or otherwise support a means for receiving a selection of one of the set of CMRs or the set of nominal resources for the measurement report, where transmitting the measurement report is based on the received selection. In some examples, the measurement report includes at least one of a periodic CSI report, a semi-persistent CSI report, an aperiodic CSI report, or any combination thereof.

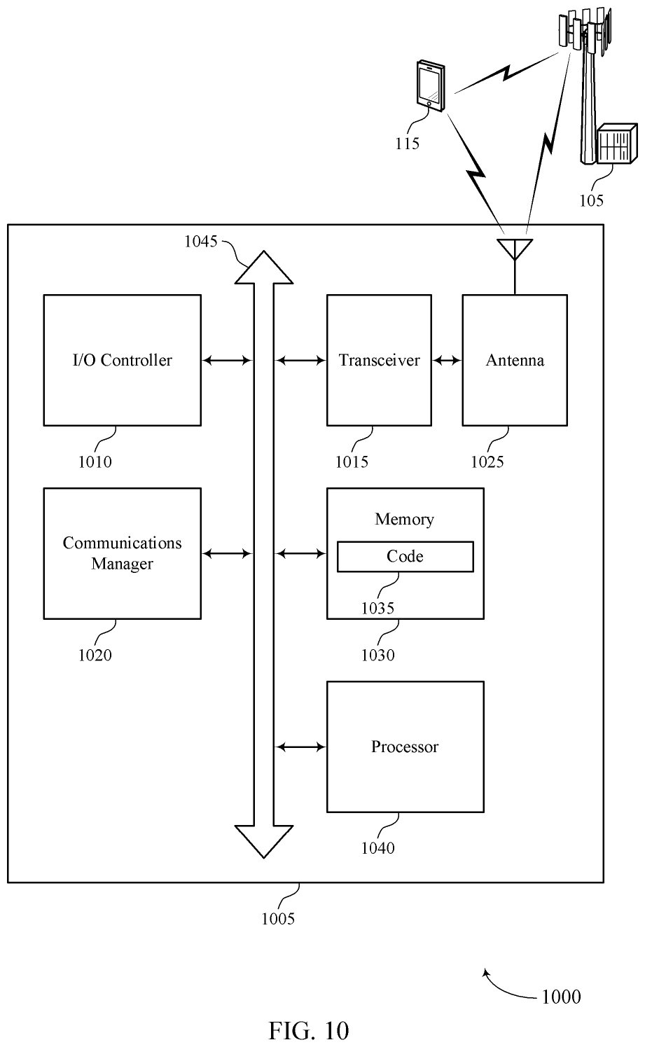

FIG. 10 shows a diagram of a system 1000 including a device 1005 that supports techniques for channel measurement with predictive beam management in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for channel measurement with predictive beam management). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 may be configured as or otherwise support a means for receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The communications manager 1020 may be configured as or otherwise support a means for performing the channel state measurement procedure based on the set of CMRs and the set of nominal resources. The communications manager 1020 may be configured as or otherwise support a means for transmitting a measurement report associated with the set of CMRs, or the set of nominal resources, or any combination thereof.

By including or configuring the communications manager 1020 in accordance with examples as described herein, the device 1005 may support techniques for improved communication reliability, reduced latency, reduced power consumption, more efficient utilization of communication resources, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for channel measurement with predictive beam management as described herein, or the processor 1040 and the memory 1030 may be otherwise configured to perform or support such operations.

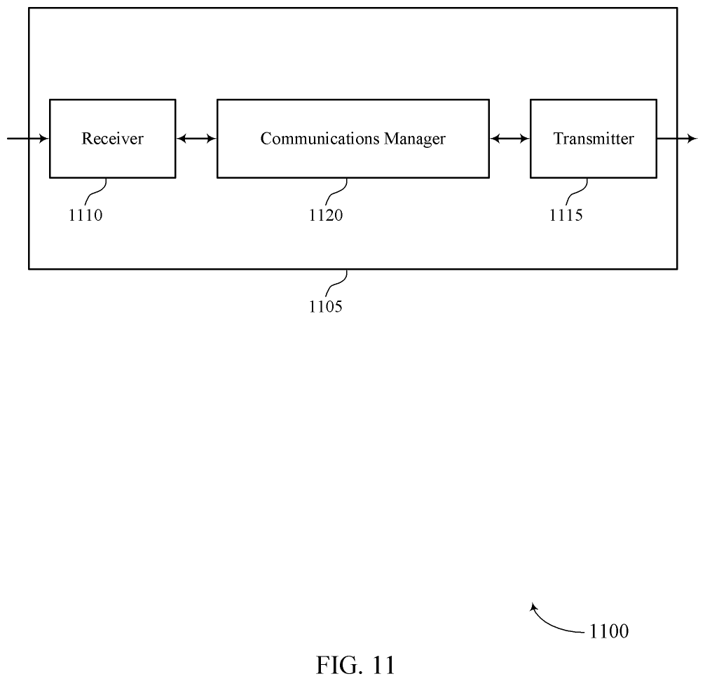

FIG. 11 shows a block diagram 1100 of a device 1105 that supports techniques for channel measurement with predictive beam management in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor (not shown). Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for channel measurement with predictive beam management as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and a memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 may be configured as or otherwise support a means for transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The communications manager 1120 may be configured as or otherwise support a means for receiving a measurement report associated with the set of CMRs, or the set of nominal resources, or any combination thereof, where the measurement report is based on performing the channel state measurement procedure using the set of CMRs and the set of nominal resources.

By including or configuring the communications manager 1120 in accordance with examples as described herein, the device 1105 (e.g., a processor controlling or otherwise coupled with the receiver 1110, the transmitter 1115, the communications manager 1120, or any combination thereof) may support techniques for reduced processing, reduced power consumption, and more efficient utilization of communication resources.

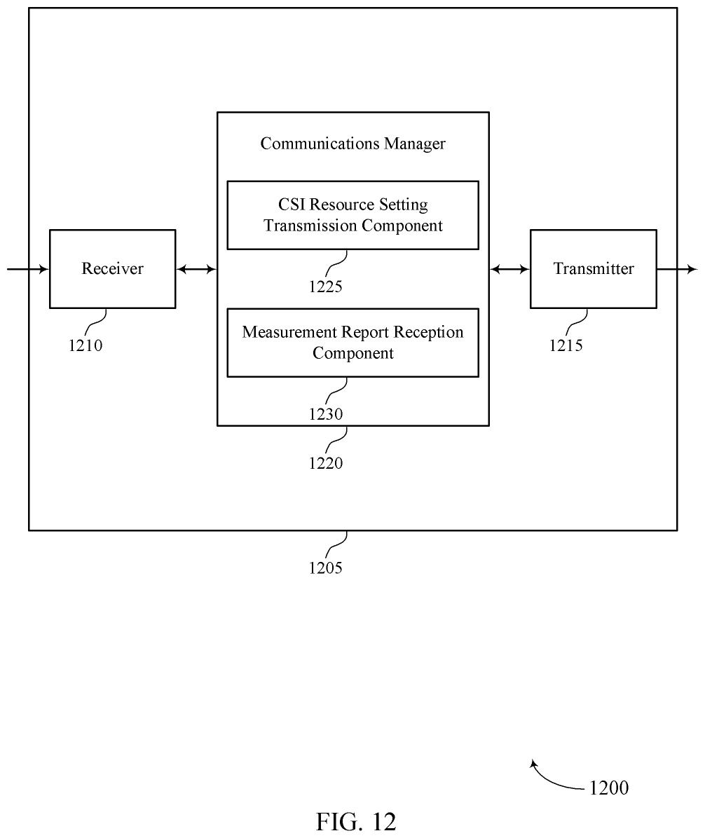

FIG. 12 shows a block diagram 1200 of a device 1205 that supports techniques for channel measurement with predictive beam management in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor (not shown). Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for channel measurement with predictive beam management as described herein. For example, the communications manager 1220 may include a CSI resource setting transmission component 1225 a measurement report reception component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The CSI resource setting transmission component 1225 may be configured as or otherwise support a means for transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The measurement report reception component 1230 may be configured as or otherwise support a means for receiving a measurement report associated with the set of CMRs, or the set of nominal resources, or any combination thereof, where the measurement report is based on performing the channel state measurement procedure using the set of CMRs and the set of nominal resources.

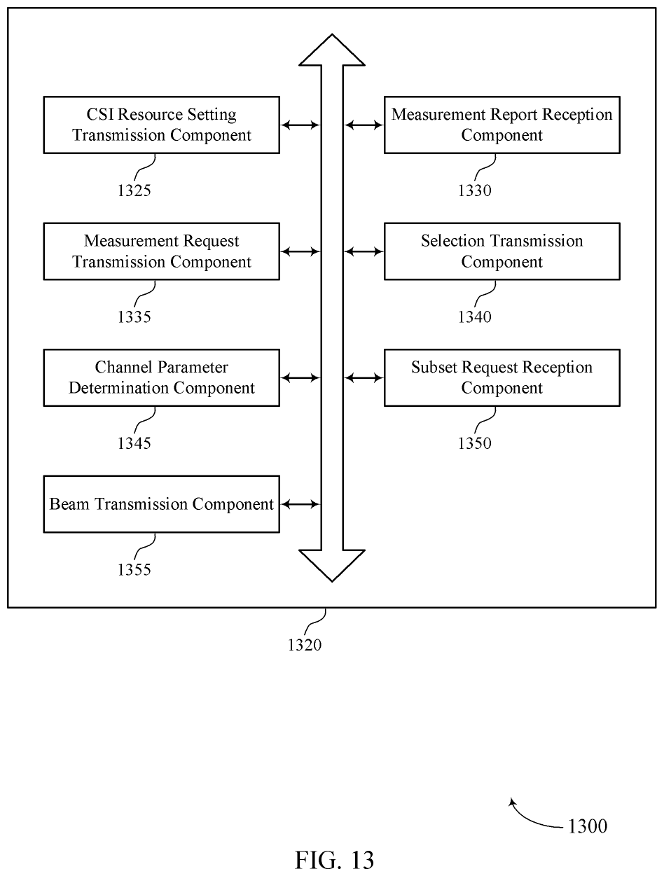

FIG. 13 shows a block diagram 1300 of a communications manager 1320 that supports techniques for channel measurement with predictive beam management in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for channel measurement with predictive beam management as described herein. For example, the communications manager 1320 may include a CSI resource setting transmission component 1325, a measurement report reception component 1330, a measurement request transmission component 1335, a selection transmission component 1340, a channel parameter determination component 1345, a subset request reception component 1350, a beam transmission component 1355, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The CSI resource setting transmission component 1325 may be configured as or otherwise support a means for transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The measurement report reception component 1330 may be configured as or otherwise support a means for receiving a measurement report associated with the set of CMRs, or the set of nominal resources, or any combination thereof, where the measurement report is based on performing the channel state measurement procedure using the set of CMRs and the set of nominal resources.

In some examples, to support transmitting the CSI resource setting, the CSI resource setting transmission component 1325 may be configured as or otherwise support a means for transmitting the CSI resource setting indicating that the set of nominal resources includes a set of CPRs.

In some examples, the measurement report reception component 1330 may be configured as or otherwise support a means for receiving a channel measurement parameter associated with the set of CMRs and a channel prediction parameter associated with the set of CPRs.

In some examples, the channel parameter determination component 1345 may be configured as or otherwise support a means for determining a quantity of channel parameters to be measured for the set of CMRs and the set of CPRs. In some examples, the measurement report reception component 1330 may be configured as or otherwise support a means for receiving a set of channel parameters associated with the set of CMRs and the set of CPRs based on the quantity of channel parameters.

In some examples, the measurement report reception component 1330 may be configured as or otherwise support a means for receiving a bitmap indicating a set of channel measurement parameters associated with the set of CMRs and a set of channel prediction parameters associated with the set of CPRs.

In some examples, the measurement report reception component 1330 may be configured as or otherwise support a means for receiving a set of bits including an indication of a set of channel measurement parameters associated with the set of CMRs and a set of channel prediction parameters associated with the set of CPRs, where a quantity of the set of channel measurement parameters is equal to a quantity of the set of channel prediction parameters. In some examples, the measurement report reception component 1330 may be configured as or otherwise support a means for receiving the set of channel measurement parameters and the set of channel prediction parameters, where the measurement report includes a single-part CSI report.

In some examples, the measurement report reception component 1330 may be configured as or otherwise support a means for receiving a first set of bits including an indication of a set of channel measurement parameters associated with the set of CMRs and a second set of bits including an indication a set of channel prediction parameters associated with the set of CPRs, where a quantity of the set of channel measurement parameters is different from a quantity of the set of channel prediction parameters. In some examples, the measurement report reception component 1330 may be configured as or otherwise support a means for receiving the set of channel measurement parameters and the set of channel prediction parameters, where the measurement report includes a two-part CSI report.

In some examples, the subset request reception component 1350 may be configured as or otherwise support a means for receiving, from the UE, a request to use a subset of the set of CMRs and a subset of the set of nominal resources in performing the channel state measurement procedure.

In some examples, to support transmitting the CSI resource setting, the CSI resource setting transmission component 1325 may be configured as or otherwise support a means for transmitting the CSI resource setting associated with the measurement report indicating that the set of CMRs includes a first subset of channel resources and the set of nominal resources includes a second subset of the channel resources.

In some examples, to support transmitting the CSI resource setting, the CSI resource setting transmission component 1325 may be configured as or otherwise support a means for transmitting a control signal indicating a partitioning between channel resources, where the set of CMRs includes a first subset of channel resources and the set of nominal resources includes a second subset of the channel resources in accordance with the partitioning.

In some examples, the control signal includes at least one of a medium access control (MAC) control element activating a semi-persistent CSI report, a MAC control element activating a semi-persistent CSI resource set, an aperiodic CSI triggering state configuration, a downlink control information, or any combination thereof. In some examples, the set of CMRs is associated with a first set of beams and the set of nominal resources is associated with a second set of beams.

In some examples, the beam transmission component 1355 may be configured as or otherwise support a means for refraining from transmitting the second set of beams to the UE. In some examples, the set of nominal resources is based on an enhanced CSI reference signal resource set configuration or a synchronization signal block resource set configuration.

In some examples, to support transmitting the CSI resource setting, the CSI resource setting transmission component 1325 may be configured as or otherwise support a means for transmitting the CSI resource setting indicating that the set of CMRs includes a first subset of channel resources and the set of nominal resources includes a second subset of the channel resources, where the second subset of the channel resources is not indicated by the network entity.

In some examples, the measurement request transmission component 1335 may be configured as or otherwise support a means for transmitting a request to perform the channel state measurement procedure based on the set of CMRs in accordance with a first frequency and based on the set of nominal resources in accordance with a second frequency different from the first frequency. In some examples, a periodicity for the set of CMRs is longer than a periodicity for the set of nominal resources.

In some examples, the selection transmission component 1340 may be configured as or otherwise support a means for transmitting a selection of one of the set of CMRs or the set of nominal resources for the measurement report, where transmitting the measurement report is based on the transmitted selection. In some examples, the measurement report includes at least one of a periodic CSI report, a semi-persistent CSI report, an aperiodic CSI report, or any combination thereof.

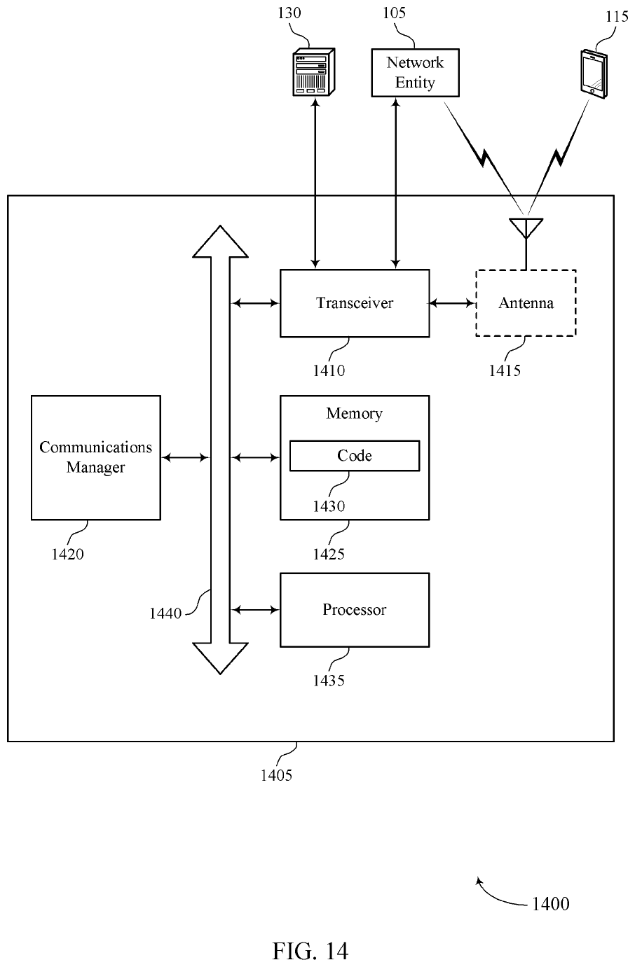

FIG. 14 shows a diagram of a system 1400 including a device 1405 that supports techniques for channel measurement with predictive beam management in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or any combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for channel measurement with predictive beam management). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 may be configured as or otherwise support a means for transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The communications manager 1420 may be configured as or otherwise support a means for receiving a measurement report associated with the set of CMRs, or the set of nominal resources, or any combination thereof, where the measurement report is based on performing the channel state measurement procedure using the set of CMRs and the set of nominal resources.

By including or configuring the communications manager 1420 in accordance with examples as described herein, the device 1405 may support techniques for improved communication reliability, reduced latency, reduced power consumption, more efficient utilization of communication resources, longer battery life, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for channel measurement with predictive beam management as described herein, or the processor 1435 and the memory 1425 may be otherwise configured to perform or support such operations.

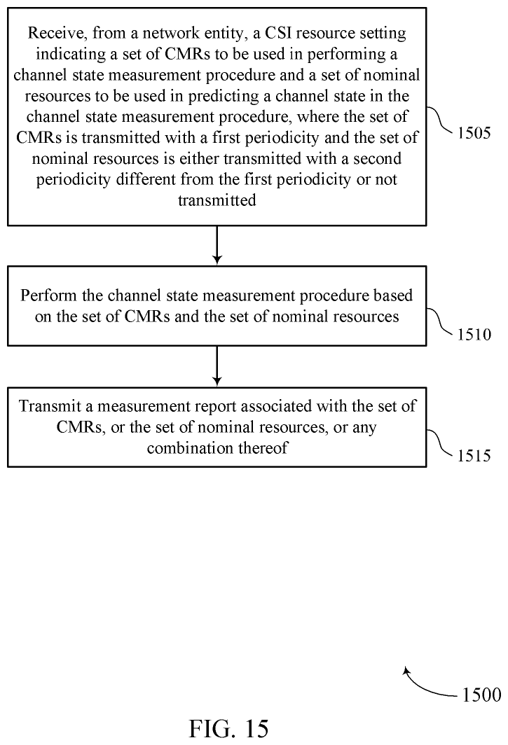

FIG. 15 shows a flowchart illustrating a method 1500 that supports techniques for channel measurement with predictive beam management in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The operations of 1505 may be performed in accordance with examples as disclosed herein. In some examples, aspects of the operations of 1505 may be performed by a CSI resource setting reception component 925 as described with reference to FIG. 9.

At 1510, the method may include performing the channel state measurement procedure based on the set of CMRs and the set of nominal resources. The operations of 1510 may be performed in accordance with examples as disclosed herein. In some examples, aspects of the operations of 1510 may be performed by a channel state measurement component 930 as described with reference to FIG. 9.

At 1515, the method may include transmitting a measurement report associated with the set of CMRs, or the set of nominal resources, or any combination thereof. The operations of 1515 may be performed in accordance with examples as disclosed herein. In some examples, aspects of the operations of 1515 may be performed by a measurement report transmission component 935 as described with reference to FIG. 9.

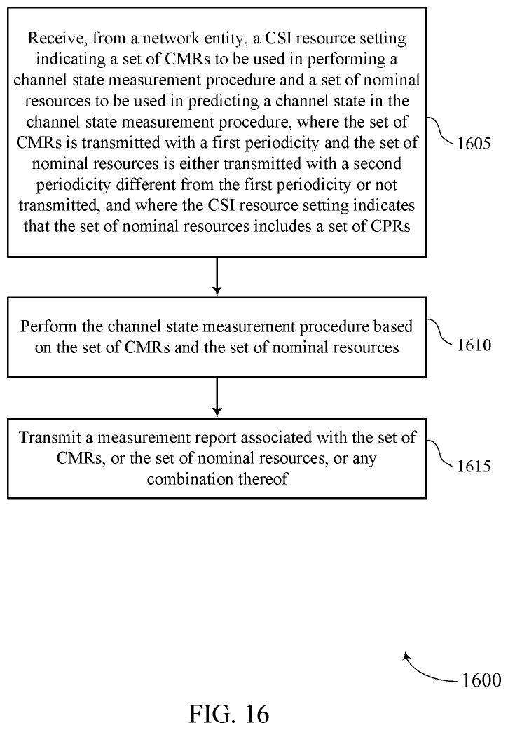

FIG. 16 shows a flowchart illustrating a method 1600 that supports techniques for channel measurement with predictive beam management in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted, and where the CSI resource setting indicates that the set of nominal resources includes a set of CPRs. The operations of 1605 may be performed in accordance with examples as disclosed herein. In some examples, aspects of the operations of 1605 may be performed by a CSI resource setting reception component 925 as described with reference to FIG. 9.

At 1610, the method may include performing the channel state measurement procedure based on the set of CMRs and the set of nominal resources. The operations of 1610 may be performed in accordance with examples as disclosed herein. In some examples, aspects of the operations of 1610 may be performed by a channel state measurement component 930 as described with reference to FIG. 9.

At 1615, the method may include transmitting a measurement report associated with the set of CMRs, or the set of nominal resources, or any combination thereof. The operations of 1615 may be performed in accordance with examples as disclosed herein. In some examples, aspects of the operations of 1615 may be performed by a measurement report transmission component 935 as described with reference to FIG. 9.

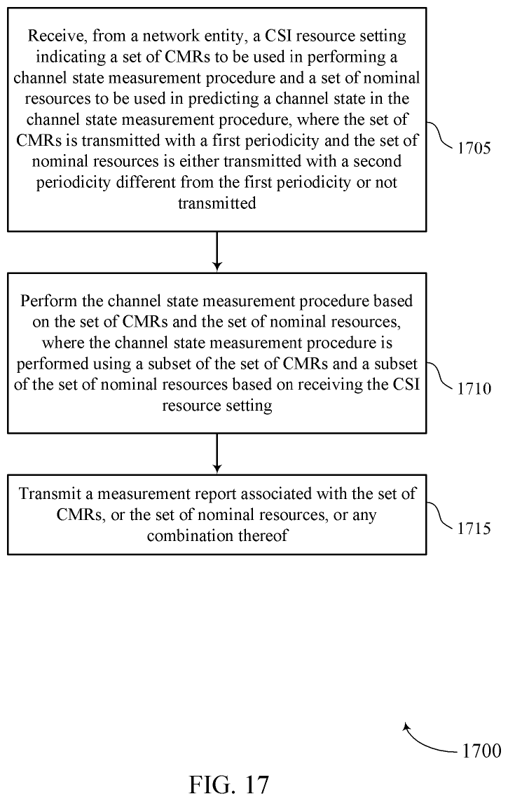

FIG. 17 shows a flowchart illustrating a method 1700 that supports techniques for channel measurement with predictive beam management in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The operations of 1705 may be performed in accordance with examples as disclosed herein. In some examples, aspects of the operations of 1705 may be performed by a CSI resource setting reception component 925 as described with reference to FIG. 9.

At 1710, the method may include the channel state measurement procedure based on the set of CMRs and the set of nominal resources, where the channel state measurement procedure is performed using a subset of the set of CMRs and a subset of the set of nominal resources based on receiving the CSI resource setting. The operations of 1710 may be performed in accordance with examples as disclosed herein. In some examples, aspects of the operations of 1710 may be performed by a channel state measurement component 930 as described with reference to FIG. 9.

At 1715, the method may include transmitting a measurement report associated with the set of CMRs, or the set of nominal resources, or any combination thereof. The operations of 1715 may be performed in accordance with examples as disclosed herein. In some examples, aspects of the operations of 1715 may be performed by a measurement report transmission component 935 as described with reference to FIG. 9.

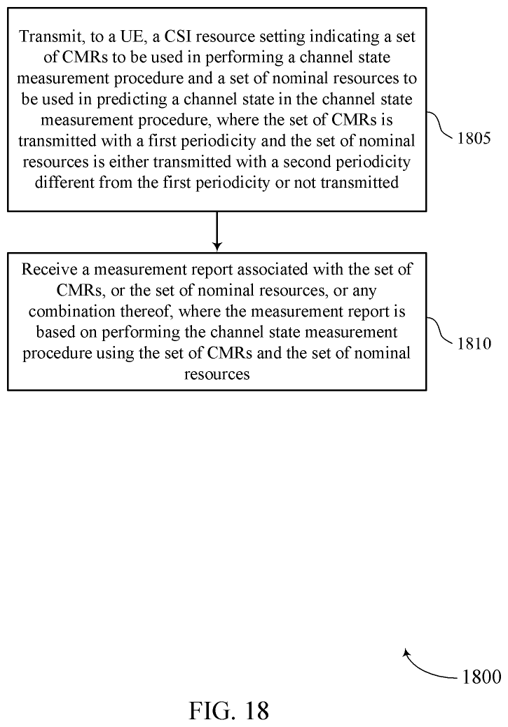

FIG. 18 shows a flowchart illustrating a method 1800 that supports techniques for channel measurement with predictive beam management in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted. The operations of 1805 may be performed in accordance with examples as disclosed herein. In some examples, aspects of the operations of 1805 may be performed by a CSI resource setting transmission component 1325 as described with reference to FIG. 13.

At 1810, the method may include receiving a measurement report associated with the set of CMRs, or the set of nominal resources, or any combination thereof, where the measurement report is based on performing the channel state measurement procedure using the set of CMRs and the set of nominal resources. The operations of 1810 may be performed in accordance with examples as disclosed herein. In some examples, aspects of the operations of 1810 may be performed by a measurement report reception component 1330 as described with reference to FIG. 13.

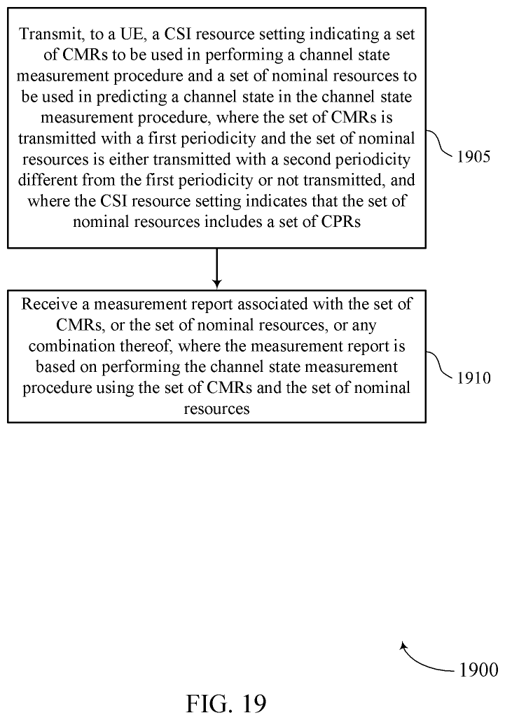

FIG. 19 shows a flowchart illustrating a method 1900 that supports techniques for channel measurement with predictive beam management in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, a CSI resource setting indicating a set of CMRs to be used in performing a channel state measurement procedure and a set of nominal resources to be used in predicting a channel state in the channel state measurement procedure, where the set of CMRs is transmitted with a first periodicity and the set of nominal resources is either transmitted with a second periodicity different from the first periodicity or not transmitted, and where the CSI resource setting indicates that the set of nominal resources includes a set of CPRs. The operations of 1905 may be performed in accordance with examples as disclosed herein. In some examples, aspects of the operations of 1905 may be performed by a CSI resource setting transmission component 1325 as described with reference to FIG. 13.

At 1910, the method may include receiving a measurement report associated with the set of CMRs, or the set of nominal resources, or any combination thereof, where the measurement report is based on performing the channel state measurement procedure using the set of CMRs and the set of nominal resources. The operations of 1910 may be performed in accordance with examples as disclosed herein. In some examples, aspects of the operations of 1910 may be performed by a measurement report reception component 1330 as described with reference to FIG. 13.

The following provides an overview of aspects of the present disclosure:
Aspect 1: A method for wireless communication at a UE, comprising: receiving, from a network entity, a channel state information resource setting indicating a set of channel measurement resources to be used in performing a channel state measurement procedure and a set of nominal resources to be used in predicting a channel state in the channel state measurement procedure, wherein the set of channel measurement resources is transmitted with a first periodicity and the set of nominal resources is either transmitted with a second periodicity different from the first periodicity or not transmitted; performing the channel state measurement procedure based at least in part on the set of channel measurement resources and the set of nominal resources; and transmitting a measurement report associated with the set of channel measurement resources, or the set of nominal resources, or any combination thereof.
Aspect 2: The method of aspect 1, wherein receiving the channel state information resource setting further comprises: receiving the channel state information resource setting indicating that the set of nominal resources comprises a set of channel prediction resources.
Aspect 3: The method of aspect 2, further comprising: transmitting a channel measurement parameter associated with the set of channel measurement resources and a channel prediction parameter associated with the set of channel prediction resources.
Aspect 4: The method of any of aspects 2 through 3, further comprising: determining a quantity of channel parameters to be measured for the set of channel measurement resources and the set of channel prediction resources; and transmitting a set of channel parameters associated with the set of channel measurement resources and the set of channel prediction resources based at least in part on the quantity of channel parameters.
Aspect 5: The method of any of aspects 2 through 4, further comprising: transmitting a bitmap indicating a set of channel measurement parameters associated with the set of channel measurement resources and a set of channel prediction parameters associated with the set of channel prediction resources.
Aspect 6: The method of any of aspects 2 through 5, further comprising: transmitting a set of bits comprising an indication of a set of channel measurement parameters associated with the set of channel measurement resources and a set of channel prediction parameters associated with the set of channel prediction resources, wherein a quantity of the set of channel measurement parameters is equal to a quantity of the set of channel prediction parameters; and transmitting the set of channel measurement parameters and the set of channel prediction parameters, wherein the measurement report comprises a single-part channel state information report.
Aspect 7: The method of any of aspects 2 through 6, further comprising: transmitting a first set of bits comprising an indication of a set of channel measurement parameters associated with the set of channel measurement resources and a second set of bits comprising an indication of a set of channel prediction parameters associated with the set of channel prediction resources, wherein a quantity of the set of channel measurement parameters is different from a quantity of the set of channel prediction parameters; and transmitting the set of channel measurement parameters and the set of channel prediction parameters, wherein the measurement report comprises a two-part channel state information report.
Aspect 8: The method of any of aspects 1 through 7, wherein performing the channel state measurement procedure further comprises: performing the channel state measurement procedure using a subset of the set of channel measurement resources and a subset of the set of nominal resources based at least in part on receiving the channel state information resource setting.
Aspect 9: The method of any of aspects 1 through 8, further comprising: transmitting, to the network entity, a request to use a subset of the set of channel measurement resources and a subset of the set of nominal resources in performing the channel state measurement procedure.
Aspect 10: The method of any of aspects 1 through 9, wherein receiving the channel state information resource setting further comprises: receiving the channel state information resource setting associated with the measurement report indicating that the set of channel measurement resources comprises a first subset of channel resources and the set of nominal resources comprises a second subset of the channel resources.
Aspect 11: The method of any of aspects 1 through 10, wherein receiving the channel state information resource setting further comprises: receiving a control signal indicating a partitioning between channel resources, wherein the set of channel measurement resources comprises a first subset of channel resources and the set of nominal resources comprises a second subset of the channel resources in accordance with the partitioning.
Aspect 12: The method of aspect 11, wherein the control signal comprises at least one of a medium access control (MAC) control element activating a semi-persistent channel state information report, a MAC control element activating a semi-persistent channel state information resource set, an aperiodic channel state information triggering state configuration, a downlink control information, or any combination thereof.
Aspect 13: The method of any of aspects 1 through 12, wherein the set of channel measurement resources is associated with a first set of beams and the set of nominal resources is associated with a second set of beams.
Aspect 14: The method of any of aspects 1 through 13, wherein the set of nominal resources is based at least in part on an enhanced channel state information reference signal resource set configuration or a synchronization signal block resource set configuration.
Aspect 15: The method of any of aspects 1 through 14, wherein receiving the channel state information resource setting further comprises: receiving the channel state information resource setting indicating that the set of channel measurement resources comprises a first subset of channel resources and the set of nominal resources comprises a second subset of the channel resources, wherein the second subset of the channel resources is not indicated by the network entity.
Aspect 16: The method of any of aspects 1 through 15, further comprising: receiving a request to perform the channel state measurement procedure based at least in part on the set of channel measurement resources in accordance with a first frequency and based at least in part on the set of nominal resources in accordance with a second frequency different from the first frequency.
Aspect 17: The method of any of aspects 1 through 16, wherein a periodicity for the set of channel measurement resources is longer than a periodicity for the set of nominal resources.
Aspect 18: The method of any of aspects 1 through 17, further comprising: receiving a selection of one of the set of channel measurement resources or the set of nominal resources for the measurement report, wherein transmitting the measurement report is based at least in part on the received selection.
Aspect 19: The method of any of aspects 1 through 18, wherein the measurement report comprises at least one of a periodic channel state information report, a semi-persistent channel state information report, an aperiodic channel state information report, or any combination thereof.
Aspect 20: A method for wireless communication at a network entity, comprising: transmitting, to a UE, a channel state information resource setting indicating a set of channel measurement resources to be used in performing a channel state measurement procedure and a set of nominal resources to be used in predicting a channel state in the channel state measurement procedure, wherein the set of channel measurement resources is transmitted with a first periodicity and the set of nominal resources is either transmitted with a second periodicity different from the first periodicity or not transmitted; and receiving a measurement report associated with the set of channel measurement resources, or the set of nominal resources, or any combination thereof, wherein the measurement report is based at least in part on performing the channel state measurement procedure using the set of channel measurement resources and the set of nominal resources.
Aspect 21: The method of aspect 20, wherein transmitting the channel state information resource setting further comprises: transmitting the channel state information resource setting indicating that the set of nominal resources comprises a set of channel prediction resources.
Aspect 22: The method of aspect 21, further comprising: receiving a channel measurement parameter associated with the set of channel measurement resources and a channel prediction parameter associated with the set of channel prediction resources.
Aspect 23: The method of any of aspects 21 through 22, further comprising: determining a quantity of channel parameters to be measured for the set of channel measurement resources and the set of channel prediction resources; and receiving a set of channel parameters associated with the set of channel measurement resources and the set of channel prediction resources based at least in part on the quantity of channel parameters.
Aspect 24: The method of any of aspects 21 through 23, further comprising: receiving a bitmap indicating a set of channel measurement parameters associated with the set of channel measurement resources and a set of channel prediction parameters associated with the set of channel prediction resources.
Aspect 25: The method of any of aspects 21 through 24, further comprising: receiving a set of bits comprising an indication of a set of channel measurement parameters associated with the set of channel measurement resources and a set of channel prediction parameters associated with the set of channel prediction resources, wherein a quantity of the set of channel measurement parameters is equal to a quantity of the set of channel prediction parameters; and receiving the set of channel measurement parameters and the set of channel prediction parameters, wherein the measurement report comprises a single-part channel state information report.
Aspect 26: The method of any of aspects 21 through 25, further comprising: receiving a first set of bits comprising an indication of a set of channel measurement parameters associated with the set of channel measurement resources and a second set of bits comprising an indication a set of channel prediction parameters associated with the set of channel prediction resources, wherein a quantity of the set of channel measurement parameters is different from a quantity of the set of channel prediction parameters; and receiving the set of channel measurement parameters and the set of channel prediction parameters, wherein the measurement report comprises a two-part channel state information report.
Aspect 27: The method of any of aspects 21 through 26, further comprising: receiving, from the UE, a request to use a subset of the set of channel measurement resources and a subset of the set of nominal resources in performing the channel state measurement procedure.
Aspect 28: The method of any of aspects 20 through 27, wherein transmitting the channel state information resource setting further comprises: transmitting the channel state information resource setting associated with the measurement report indicating that the set of channel measurement resources comprises a first subset of channel resources and the set of nominal resources comprises a second subset of the channel resources.
Aspect 29: The method of any of aspects 20 through 28, wherein transmitting the channel state information resource setting further comprises: transmitting a control signal indicating a partitioning between channel resources, wherein the set of channel measurement resources comprises a first subset of channel resources and the set of nominal resources comprises a second subset of the channel resources in accordance with the partitioning.
Aspect 30: The method of aspect 29, wherein the control signal comprises at least one of a medium access control (MAC) control element activating a semi-persistent channel state information report, a MAC control element activating a semi-persistent channel state information resource set, an aperiodic channel state information triggering state configuration, a downlink control information, or any combination thereof.
Aspect 31: The method of any of aspects 20 through 30, wherein the set of channel measurement resources is associated with a first set of beams and the set of nominal resources is associated with a second set of beams.
Aspect 32: The method of aspect 31, further comprising: refraining from transmitting the second set of beams to the UE.
Aspect 33: The method of any of aspects 20 through 32, wherein the set of nominal resources is based at least in part on an enhanced channel state information reference signal resource set configuration or a synchronization signal block resource set configuration.
Aspect 34: The method of any of aspects 20 through 33, wherein transmitting the channel state information resource setting further comprises: transmitting the channel state information resource setting indicating that the set of channel measurement resources comprises a first subset of channel resources and the set of nominal resources comprises a second subset of the channel resources, wherein the second subset of the channel resources is not indicated by the network entity.
Aspect 35: The method of any of aspects 20 through 34, further comprising: transmitting a request to perform the channel state measurement procedure based at least in part on the set of channel measurement resources in accordance with a first frequency and based at least in part on the set of nominal resources in accordance with a second frequency different from the first frequency.
Aspect 36: The method of any of aspects 20 through 35, wherein a periodicity for the set of channel measurement resources is longer than a periodicity for the set of nominal resources.
Aspect 37: The method of any of aspects 20 through 36, further comprising: transmitting a selection of one of the set of channel measurement resources or the set of nominal resources for the measurement report, wherein transmitting the measurement report is based at least in part on the transmitted selection.
Aspect 38: The method of any of aspects 20 through 37, wherein the measurement report comprises at least one of a periodic channel state information report, a semi-persistent channel state information report, an aperiodic channel state information report, or any combination thereof.
Aspect 39: An apparatus for wireless communication at a UE, comprising a processor; and a memory coupled with the processor, with instructions stored in the memory, the instructions being executable by the processor to cause the apparatus to perform a method of any of aspects 1 through 19.
Aspect 40: An apparatus for wireless communication at a UE, comprising at least one means for performing a method of any of aspects 1 through 19.
Aspect 41: A non-transitory computer-readable medium storing code for wireless communication at a UE, the code comprising instructions executable by a processor to perform a method of any of aspects 1 through 19.
Aspect 42: An apparatus for wireless communication at a network entity, comprising a processor; and a memory coupled with the processor, with instructions stored in the memory, the instructions being executable by the processor to cause the apparatus to perform a method of any of aspects 20 through 38.
Aspect 43: An apparatus for wireless communication at a network entity, comprising at least one means for performing a method of any of aspects 20 through 38.
Aspect 44: A non-transitory computer-readable medium storing code for wireless communication at a network entity, the code comprising instructions executable by a processor to perform a method of any of aspects 20 through 38.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1-38. (canceled)

39. An apparatus for wireless communication at a user equipment (UE), comprising:
at least one processor; and
at least one memory coupled with the at least one processor, with instructions stored in the at least one memory, the instructions being executable by the at least one processor, individually or in any combination, to cause the apparatus to:
receive, from a network entity, a channel state information resource setting indicating a set of channel measurement resources to be used in performing a channel state measurement procedure and a set of nominal resources to be used in predicting a channel state in the channel state measurement procedure, wherein the set of channel measurement resources is transmitted with a first periodicity and the set of nominal resources is either transmitted with a second periodicity different from the first periodicity or not transmitted;
perform the channel state measurement procedure based at least in part on the set of channel measurement resources and the set of nominal resources; and
transmit a measurement report associated with the set of channel measurement resources, or the set of nominal resources, or any combination thereof.

40. The apparatus of claim 39, wherein the instructions to receive the channel state information resource setting are further executable by the at least one processor, individually or in any combination, to cause the apparatus to:
receive the channel state information resource setting indicating that the set of nominal resources comprises a set of channel prediction resources.

41. The apparatus of claim 40, wherein the instructions are further executable by the at least one processor, individually or in any combination, to cause the apparatus to:
transmit a channel measurement parameter associated with the set of channel measurement resources and a channel prediction parameter associated with the set of channel prediction resources.

42. The apparatus of claim 40, wherein the instructions are further executable by the at least one processor, individually or in any combination, to cause the apparatus to:
determine a quantity of channel parameters to be measured for the set of channel measurement resources and the set of channel prediction resources; and
transmit a set of channel parameters associated with the set of channel measurement resources and the set of channel prediction resources based at least in part on the quantity of channel parameters.

43. The apparatus of claim 40, wherein the instructions are further executable by the at least one processor, individually or in any combination, to cause the apparatus to:
transmit a bitmap indicating a set of channel measurement parameters associated with the set of channel measurement resources and a set of channel prediction parameters associated with the set of channel prediction resources.

44. The apparatus of claim 40, wherein the instructions are further executable by the at least one processor, individually or in any combination, to cause the apparatus to:
transmit a set of bits comprising an indication of a set of channel measurement parameters associated with the set of channel measurement resources and a set of channel prediction parameters associated with the set of channel prediction resources, wherein a quantity of the set of channel measurement parameters is equal to a quantity of the set of channel prediction parameters; and
transmit the set of channel measurement parameters and the set of channel prediction parameters, wherein the measurement report comprises a single-part channel state information report.

45. The apparatus of claim 40, wherein the instructions are further executable by the at least one processor, individually or in any combination, to cause the apparatus to:
transmit a first set of bits comprising an indication of a set of channel measurement parameters associated with the set of channel measurement resources and a second set of bits comprising an indication of a set of channel prediction parameters associated with the set of channel prediction resources, wherein a quantity of the set of channel measurement parameters is different from a quantity of the set of channel prediction parameters; and
transmit the set of channel measurement parameters and the set of channel prediction parameters, wherein the measurement report comprises a two-part channel state information report.

46. The apparatus of claim 39, wherein the instructions to perform the channel state measurement procedure are further executable by the at least one processor, individually or in any combination, to cause the apparatus to:
perform the channel state measurement procedure using a subset of the set of channel measurement resources and a subset of the set of nominal resources based at least in part on receiving the channel state information resource setting.

47. The apparatus of claim 39, wherein the instructions are further executable by the at least one processor, individually or in any combination, to cause the apparatus to:
transmit, to the network entity, a request to use a subset of the set of channel measurement resources and a subset of the set of nominal resources in performing the channel state measurement procedure.

48. The apparatus of claim 39, wherein the instructions to receive the channel state information resource setting are further executable by the at least one processor, individually or in any combination, to cause the apparatus to:
receive the channel state information resource setting associated with the measurement report indicating that the set of channel measurement resources comprises a first subset of channel resources and the set of nominal resources comprises a second subset of the channel resources.

49. The apparatus of claim 39, wherein the instructions to receive the channel state information resource setting are further executable by the at least one processor, individually or in any combination, to cause the apparatus to:
receive a control signal indicating a partitioning between channel resources, wherein the set of channel measurement resources comprises a first subset of channel resources and the set of nominal resources comprises a second subset of the channel resources in accordance with the partitioning.

50. The apparatus of claim 49, wherein the control signal comprises at least one of a medium access control (MAC) control element activating a semi-persistent channel state information report, a MAC control element activating a semi-persistent channel state information resource set, an aperiodic channel state information triggering state configuration, a downlink control information, or any combination thereof.

51. The apparatus of claim 39, wherein:
the set of channel measurement resources is associated with a first set of beams and the set of nominal resources is associated with a second set of beams,
the set of nominal resources is based at least in part on an enhanced channel state information reference signal resource set configuration, or
the set of nominal resources is based at least in part on an a synchronization signal block resource set configuration, or any combination thereof.

52. (canceled)

53. The apparatus of claim 39, wherein the instructions to receive the channel state information resource setting are further executable by the at least one processor, individually or in any combination, to cause the apparatus to:
receive the channel state information resource setting indicating that the set of channel measurement resources comprises a first subset of channel resources and the set of nominal resources comprises a second subset of the channel resources, wherein the second subset of the channel resources is not indicated by the network entity.

54. The apparatus of claim 39, wherein the instructions are further executable by the at least one processor, individually or in any combination, to cause the apparatus to:
receive a request to perform the channel state measurement procedure based at least in part on the set of channel measurement resources in accordance with a first frequency and based at least in part on the set of nominal resources in accordance with a second frequency different from the first frequency.

55. The apparatus of claim 39, wherein a periodicity for the set of channel measurement resources is longer than a periodicity for the set of nominal resources.

56. The apparatus of claim 39, wherein the instructions are further executable by the at least one processor, individually or in any combination, to cause the apparatus to:
receive a selection of one of the set of channel measurement resources or the set of nominal resources for the measurement report, wherein transmitting the measurement report is based at least in part on the received selection.

57. The apparatus of claim 39, wherein the measurement report comprises at least one of a periodic channel state information report, a semi-persistent channel state information report, an aperiodic channel state information report, or any combination thereof.

58. An apparatus for wireless communication at a network entity, comprising:
at least one processor; and
at least one memory coupled with the at least one processor, with instructions stored in the at least one memory, the instructions being executable by the at least one processor, individually or in any combination, to cause the apparatus to:
transmit, to a user equipment (UE), a channel state information resource setting indicating a set of channel measurement resources to be used in performing a channel state measurement procedure and a set of nominal resources to be used in predicting a channel state in the channel state measurement procedure, wherein the set of channel measurement resources is transmitted with a first periodicity and the set of nominal resources is either transmitted with a second periodicity different from the first periodicity or not transmitted; and
receive a measurement report associated with the set of channel measurement resources, or the set of nominal resources, or any combination thereof, wherein the measurement report is based at least in part on performing the channel state measurement procedure using the set of channel measurement resources and the set of nominal resources.

59-78. (canceled)

79. A non-transitory computer-readable medium storing code for wireless communication at a user equipment (UE), the code comprising instructions executable by at least one processor to:
receive, from a network entity, a channel state information resource setting indicating a set of channel measurement resources to be used in performing a channel state measurement procedure and a set of nominal resources to be used in predicting a channel state in the channel state measurement procedure, wherein the set of channel measurement resources is transmitted with a first periodicity and the set of nominal resources is either transmitted with a second periodicity different from the first periodicity or not transmitted;
perform the channel state measurement procedure based at least in part on the set of channel measurement resources and the set of nominal resources; and
transmit a measurement report associated with the set of channel measurement resources, or the set of nominal resources, or any combination thereof.

80-118. (canceled)
